(19) United States
(12) Patent Application Publication
(10) Pub. No.: US 2009/0276955 A1
(43) Pub. Date: Nov. 12, 2009

(54) PATIENT TRANSFER SYSTEM WITH ASSOCIATED FRAMES AND LIFT CARTS

(75) Inventors: Frederic Palay, Sugarloaf Key, FL (US); William E. Burak, JR., Austin, TX (US)

Correspondence Address: DUBOIS, BRYANT, CAMPBELL & SCHWARTZ, LLP, 700 LAVACA STREET, SUITE 1300, AUSTIN, TX, 78701, US

(73) Assignee: Ergo-Asyst Technology LLC, Austin, TX (US)

(21) Appl. No.: 12/488,327

(22) Filed: Jun. 19, 2009

Related U.S. Application Data
(63) Continuation of application No. 11/375,536, filed on Mar. 14, 2006, now Pat. No. 7,578,012.
(60) Provisional application No. 60/661,372, filed on Mar. 14, 2005.
(60) Provisional application No. 60/704,372, filed on Aug. 1, 2005.

(51) Int. Cl. A61G 7/10

(52) U.S. Cl. 5/87.1; 5/81.1 R; 5/83.1; 5/86.1

(57) ABSTRACT

The invention is directed to a patient transfer system with associated patient support frames, lift carts, lifts, carts, and other accessories for use therewith. The support frames of the present invention as depicted in the exemplary embodiments are designed to: (a) provide rigidity (exoskeleton) to the human body for positioning to provide stability for purposes of transferring, lifting and/or transporting the subject via a mobile device, such as a powered lift device; (b) a male/female coupling for coupling to a tine or other carriage mechanism of a lifting device thereto for the purpose of moving or lifting the subject; and/or (c) be used as a support or frame that will interact with the body as an exoskeleton to aid with the activities of daily living.

### CROSS REFERENCE TO RELATED APPLICATIONS

The present application is a continuation application of U.S. patent application Ser. No. 11/375,536 filed Mar. 14, 2006 in the name of Frederick Palay and William E. Burak Jr., entitled “Patient Transfer System With Associated Frames and Lift Carts”, which claims priority from and incorporates by reference prior U.S. Provisional Patent Application Ser. No. 60/661,372, filed Mar. 14, 2005, and also claims the benefit of U.S. Provisional Patent Application Ser. No. 60/704,372, filed Aug. 1, 2005.

### BACKGROUND

The act of simply moving a patient from one location to another can be readily performed with various existing devices such as the wheelchair. However, most activities of daily living require transfer to and from specific settings such as the bed, chair, commode, shower, bath or vehicle. Traditionally, this transfer has been a manual task performed by caregivers. Unfortunately, the risk of low back pain and musculoskeletal injury increases with the frequency of patient handling.

Rapid growth in the lift segment is outpacing pure demographics due to the epidemic shortage in the nursing workforce. Occupational Safety and Health Administration (OSHA) regulatory policies, and public concern for quality care in nursing homes and hospitals. Workplace injury as a result of lifting and moving patients is a major problem for the nursing industry, which is already in high demand. In fact, there are “safe-lifting” or “no-lift” policies in effect in nursing homes and hospitals across the country. OSHA has concluded that workers' injuries in nursing homes alone will reach 200,000 incidents, at a cost of almost $1 billion dollars, per year. Most of these injuries are directly related to patient transfers. Injuries to caregivers in the home care setting are estimated to be even higher due to the lack of proper equipment.

Proper use of patient lift products and systems has been shown to dramatically reduce workplace injury. Known products include hoist floor-based lifts and ceiling-based lifts. Floor-based lifts utilize a large “crane-line” lift unit that lifts the patient with a fabric sling. These products are outdated in design, difficult to use, can be unsafe, and do not serve as a solution to mobility (transportation) aid. Furthermore, many known institutional floor-based lifts cannot be stored in the patients' room due to their large size and, instead, are kept in distant locations and shared among all patients on the nursing unit or floor. This practice is not conducive to easy access and leads to underutilization. Ceiling-based lifts, using the same fabric slings, are becoming popular because of these storage issues, but are very expensive and require changes to infrastructure for installation. Other drawbacks include patient anxiety and patient safety issues.

### SUMMARY

The present invention relates generally to patient transfer systems and, more particularly, to a patient transfer system including a vertical support platform. In one embodiment, the patient transfer system may include a lift cart, a vertical support platform, and at least two support straps. The lift cart may include a vertical lift mechanism for lifting the vertical support platform. The vertical support platform may support the weight of a patient. The at least two straps may be releasably coupled to the vertical support platform. The at least two straps may also provide support for at least a portion of a patient's torso and a patient's thighs. The patient's hips may rest lower than the top of the vertical support platform, the patient's head may rest higher than the top of the vertical support platform, and the vertical support platform may extend horizontally from the lift cart across the patient's anterior.

In another embodiment, the patient transfer system may include a lift cart, a vertical support platform, and at least two support straps. The lift cart may include a vertical lift mechanism for lifting the vertical support platform. The vertical support platform may support a patient's weight. The at least two straps may be releasably coupled to the vertical support platform. The at least two straps may, when the patient is being transported, provide support for at least a portion of a patient's torso and a patient's thighs. The patient's waist may rest generally below the height of the vertical support platform, the patient's neck may rest higher than the top of the vertical support platform, and the vertical support platform may extend horizontally from said lift cart generally between the patient's head and the patient's thighs.

In yet another embodiment, the patient transfer system includes a lift cart, a vertical support platform, and at least two support straps. The lift cart may include a vertical lift mechanism for lifting the vertical support platform. The vertical support platform may extend horizontally from said lift cart and may support a patient's weight. The at least two straps may be releasably coupled to the vertical support platform. When the patient is being transported, the at least two straps may provide support for at least a portion of a patient's torso and a patient's thighs. The patient's waist may rest below the top of the vertical support platform, the patient's head may rest above the top of the vertical support platform, and the patient's hips may rest generally parallel to the direction of the horizontal extension of the vertical support platform.

Exemplary embodiments of the present invention describe an ergonomically rigid frame assembled from two or more parts about the patient, for assisting the transport of the patient from a bed to another bed or to another location, position or activity.

Exemplary embodiments of the present invention also describe a patient transfer system that is able to be positioned under the patient without lifting or moving the patient's center of gravity (i.e., without lifting, moving or rolling the patient's buttocks).

Exemplary embodiments of the present invention also describe a patient transfer system that is able to be positioned above a patient and affixed to a patient without lifting or moving the patient's center of gravity (i.e., without lifting, moving, or rolling the patient's buttocks).

Exemplary embodiments of the present invention also describe a patient transfer system that includes a receptacle for receiving a tine, fork, or other coupling device of a lift cart, lift, cart or a carriage of another lifting device (such as a hoist, a stair-lift, etc.); or alternatively includes some other sort of coupling, such as a male coupling, for coupling to a complementary coupling of a mobile lift cart, lift, cart or carriage of another lifting device (such as a hoist, a stair-lift, etc.).

Exemplary embodiments of the present invention also describe a patient transfer system that has a dual functionality of assisting in movement of the patient as summarized above, but also serving as a platform for a patient mobility device (such as a wheelchair, motorized scooter, or motor vehicle).

Exemplary embodiments of the present invention also describe a patient transfer system that has articulating hinges so that the patient can be repositioned for different activities.

Exemplary embodiments of the present invention also describe a patient transfer system that has a lock that automatically engages when the lifting device is coupled to a frame.

Exemplary embodiments of the present invention also describe a patient transfer system with the rigid frame portion designed to be attached to the anterior side of the patient; or, alternatively designed to be attached to the posterior side of a patient.

Exemplary embodiments of the present invention also describe a patient transfer system with separate or combined coupling mechanisms for mounting to both a lift device and a mobility device.

Exemplary embodiments of the present invention also describe a patient transfer system for assisting the transport of the patient from a bed to another bed or to another location, position or activity that includes a rigid upper body component pivotally coupled to a rigid lower body component and includes at least one strap/belt adapted to be situated between the bed and the patient (having opposed flaps extending laterally from beneath the patient) for fastening to one of the upper or lower body components when the frame is installed on the patient.

Exemplary embodiments of the present invention also describe a patient transfer system where the lower body component is provided beneath the legs of the patient and the upper body component includes a pair of vertically extending bars adapted to be positioned on opposite lateral sides of the patient and fastened to the respective pair of opposed flaps.

Exemplary embodiments of the present invention also describe a patient transfer system that includes at least one strap/belt positioned beneath the patient's back (while lying on the bed, chair, stretcher and the like) and at least one strap/belt positioned beneath the patient's legs (while lying on the bed, chair, stretcher and the like) , which respectively are fastened to a frontal, upper-body component and a frontal leg component of a frame.

Exemplary embodiments of the present invention also describe a patient transfer system that includes a receptacle(s) for receiving a tine(s) or a carriage(s) of a lifting/transporting cart or device.

Exemplary embodiments of the present invention also describe a patient transfer system for assisting the transport of the patient from a bed to another bed or to another location, position or activity that includes at least a pair of hollow-spaces/receptacles provided between a frame and the bed for receiving a corresponding pair of tines/carriages of a patient transfer device/cart, where one hollow-space/receptacle is provided approximate a leg region and one hollow-space/receptacle is provided approximate a back region.

Exemplary embodiments of the present invention also describe a patient transfer system where the receptacle(s) or hollow-space(s) are built into a frame.

Exemplary embodiments of the present invention also describe a patient transfer system where the receptacle(s) or hollow-space(s) are provided by jacks or other lifts between a frame and a bed.

Exemplary embodiments of the present invention also describe a patient transfer system that includes a hinge approximate the hip and a hinge approximate the knee and the tines/carriages of the lift device are adjustable to configure the frame and patient between a flat position and a sitting and/or kneeling position, for example.

Exemplary embodiments of the present invention also describe a patient mobility device with configurable appendages which allow it to be used as a bed lift in one configuration and a cart in another configuration.

Exemplary embodiments of the present invention also describe a combination patient mobility and lifting device with folding handles.

Exemplary embodiments of the present invention also describe a patient lift device including an extendable horizontal member supported on each end.

### BRIEF DESCRIPTION OF THE DRAWINGS

FIGS. 1-8 illustrate various perspective views and uses of first embodiments of the present invention; more specifically, FIGS. 1A-1C and 1E illustrate side views of the exemplary patient support frame supporting a patient in various positions; FIG. 1D is a perspective view of the patient support frame supporting a patient in a supine position; FIG. 1F is a perspective view of the patient support frame supporting a patient in a supine position and an associated lift cart; FIGS. 2A-2C disclose a first step in the process of positioning the frame on the patient; FIGS. 3A-3C illustrate the patient's legs being strapped to the lower thigh support component; FIGS. 4A-4C show lifting the patient's head or back and positioning the upper back support portion and coupling it to the lower thigh support portion; FIGS. 5A-5C show the patient strapped to the rigid assembled frame; FIGS. 6A-6C illustrate lifting the patient from the bed and moving the patient to the desired location or activity; FIGS. 7A-7D illustrate a mobility base that can be coupled to the frame; FIGS. 8A-8F show the patient strapped to the frame and an associated receptacle;

FIGS. 9A-9F illustrate various perspective views and uses of second embodiments of the present invention;

FIGS. 10-12 illustrate various perspective views and uses of third embodiments of the present invention; more specifically, FIGS. 10A-10E show the support frame of the third exemplary embodiment; FIGS. 11A-11D further depict the support frame of the third exemplary embodiment; FIGS. 12A-12D illustrate various adaptations of and accessories for use with the third exemplary embodiments;

FIGS. 13A-13E illustrate various perspective views and uses of a fourth embodiment of the present invention;

FIGS. 14-15 illustrate various perspective views and uses of fifth embodiments of the present invention; more specifically, FIGS. 14A-14C show a patient transfer system with an associated patient support frame and lift cart according to fifth exemplary embodiments of the present invention; FIGS. 15A-15G further depict a patient transfer system with an associated patient support frame and lift cart according to fifth exemplary embodiments of the present invention;

FIGS. 16A-16E illustrate various perspective views of alternate uses of the lift cart devices disclosed with respect to the present invention;

FIGS. 17-24 illustrate various perspective views and uses of sixth embodiments of the present invention; more specifically, FIG. 17 shows a frame assembly; FIG. 18 shows a patient in a sitting position with the frame assembly donned; FIG. 19 shows a lateral bed extractor; FIG. 20 shows the lateral bed extractor coupled with the frame assembly holding a patient; FIG. 21 shows a forward cart unit; FIG. 22 shows the cart unit holding a frame assembly with a patient; FIG. 23 shows the cart unit in its collapsed configuration; FIG. 24 shows an exemplary space-saving storage scheme;

FIGS. 25-28 illustrate various perspective views and uses of seventh embodiments of the present invention; more specifically, FIG. 25 shows frame assembly; FIG. 26 shows the frame donned to a patient; FIG. 27 shows the extensible bed extractor; FIG. 28 shows the extensible bed extractor attached to the frame assembly containing a patient;

FIGS. 29 and 30 illustrate an optional pallet/seat for use in addition to various embodiments of the present invention disclosed in the present application; more specifically, FIG. 29 shows a pallet; FIG. 30 shows a pallet placed on a chair ready to receive a patient;

FIGS. 31-37 illustrate various perspective views and uses of an eighth embodiment of the present invention; more specifically, FIG. 31 shows a frame assembly; FIG. 32 shows the frame assembly in place on a patient; FIG. 33 shows a rotating fork cart; FIG. 34 shows a rotating fork cart holding a patient who is fastened within a frame assembly; FIG. 35 illustrates the rotating fork cart in another configuration; FIG. 36 shows the forks being inserted into the front receptacles of the frame assembly; FIG. 37 shows a rotating fork cart with its forks mated with a pallet;

FIGS. 38A-38E illustrate mechanisms for retaining retainer straps (or similar devices) associated with certain embodiments of the present invention to a bed frame or bed;

FIGS. 39A-39I illustrate various perspective and elevational views and uses of a ninth embodiment of the present invention;

FIGS. 40A-40P illustrate various perspective and elevational views and uses of the ninth embodiment (and alternate designs thereof) of the present invention;

FIGS. 41A-41F illustrate another exemplary coupling between a frame/pallet device and a lift/mobility device according to the present invention;

FIGS. 42A-42B illustrate various perspective views of a tenth embodiment of the present invention;

FIGS. 43A-43D illustrate various perspective and elevational views of certain modifications and uses applicable to many of the embodiments described herein; and

FIG. 44A-44B illustrate an alternate light-weight lift mechanism usable for many of the embodiments described herein, capable of being disassembled or collapsed for use with vehicles.

### DETAILED DESCRIPTION

The present invention is directed to patient transfer systems with associated patient support frames, lift carts, lifts, carts, and other accessories for use therewith. The present invention is also directed to methods associated with such systems, components and accessories. The support frames of the present invention as depicted in the exemplary embodiments are designed to: (a) provide rigidity (exoskeleton) to the human body for positioning to provide stability for purposes of transferring, lifting and/or transporting the subject via a mobile device, such as a powered lift device; (b) create or provide female coupling such as a space or a receptacle to allow insertion/coupling of a tine or other carriage of a lifting/mobility device thereto for the purpose of moving or lifting the subject, or provide some other sort of coupling mechanism (such as a male coupling) for coupling to a lift mechanism of a lifting device; and/or (c) be used as a support or frame that will interact with the body as an exoskeleton to aid with the activities of daily living.

Each exemplary system and frame is designed according to an intended use in supporting, lifting and/or transporting patients in at least one of three Out of Bed Assistance Categories (OBAC) for non-ambulatory disabled individuals: Category 1—disabled, self sufficient (requires no human assistance); Category 2—disabled and partially bedridden (requires some human assistance) and (c) Category 3—disabled and completely bedridden (requires substantially 100% human assistance).

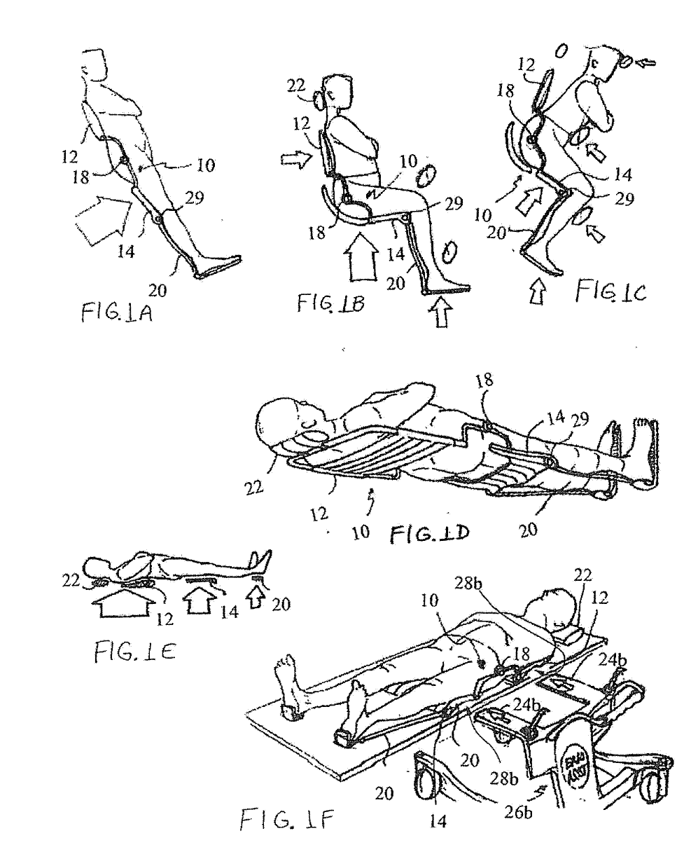

FIGS. 1A-1F, 2A-2C, 3A-3C, 4A-4C, 5A-5C, 6A-6C, 7A-7D, 8A-8F depict a patient transfer system with an associated two-piece patient support frame and lift cart according to first exemplary embodiments of the present invention. The first exemplary embodiments are designed specifically to assist Category 2 patients. The exemplary embodiments of FIGS. 1A-1F, 2A-2C, 3A-3C, 4A-4C, 5A-5C, 6A-6C, 7A-7D, 8A-8F provide a two-piece patient support frame 10 (referred to in the attached figures as the “ErgoFrame”) for providing rigid support to a patient's body to facilitate transfers of the patient bed-to-bed or bed-to-chair, etc. The frame 10 includes an upper back support component 12 and a lower thigh support component 14 adapted to be coupled together and at an attachment point 16. There may also be an articulating hinge 18 present at the hip area of the patient when assembled. Optionally, the lower thigh support portion may also include heel and foot support components 20 extending therefrom (including an articulating knee hinge) while the upper back support component 12 may optionally include a head supporting component 22.

The upper back support component 12 essentially includes a U-shaped rigid framework with flexible webbing or straps extending laterally between the two vertical bars of the U-shaped rigid framework for supporting the patient's torso. The lower thigh support component 14 includes a pair of opposed, rigid vertical bars and includes a cushioned rigid platform extending therebetween for supporting the patient's thighs.

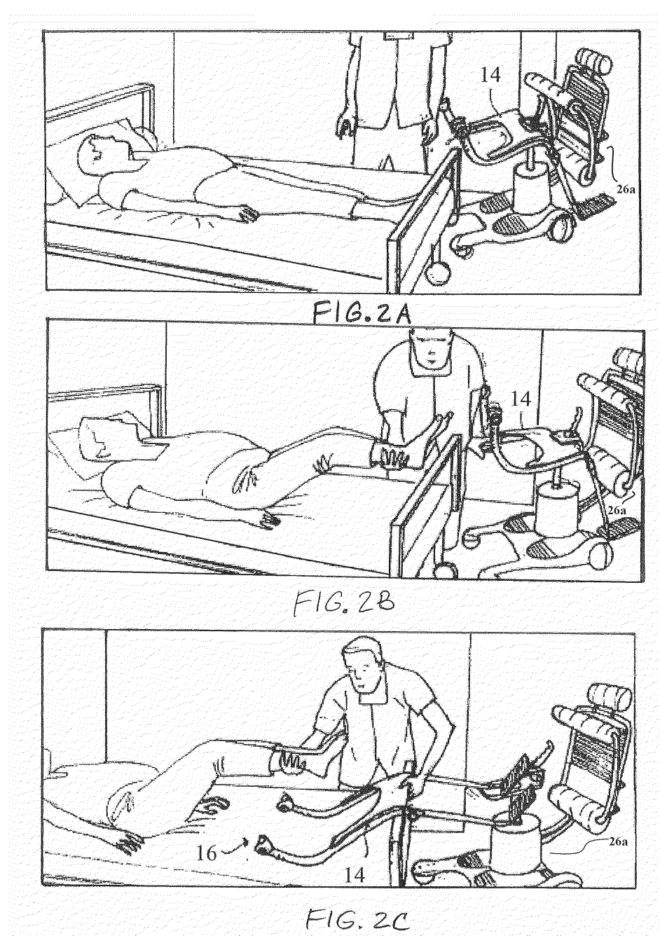

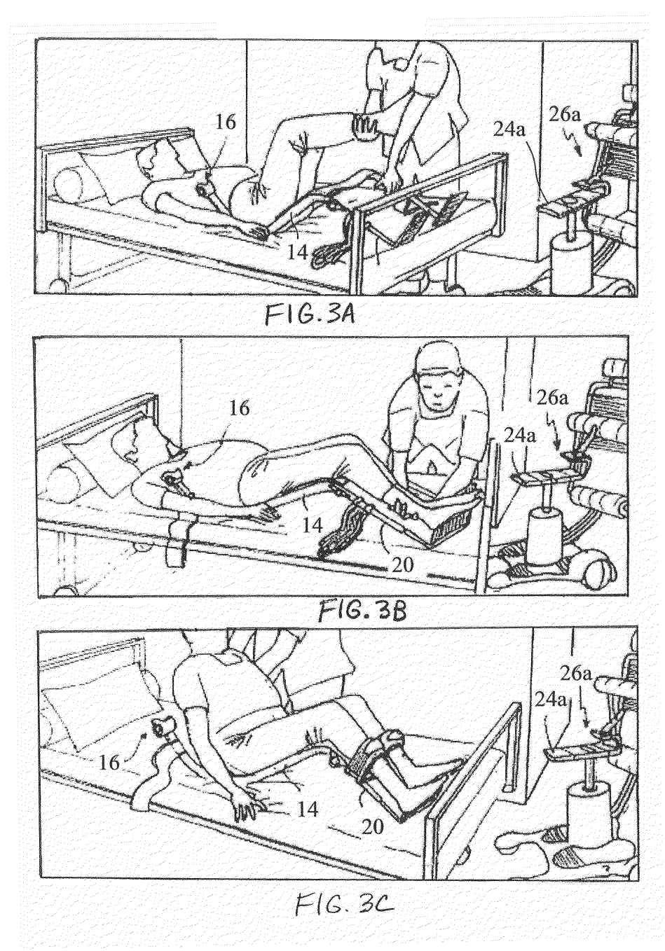

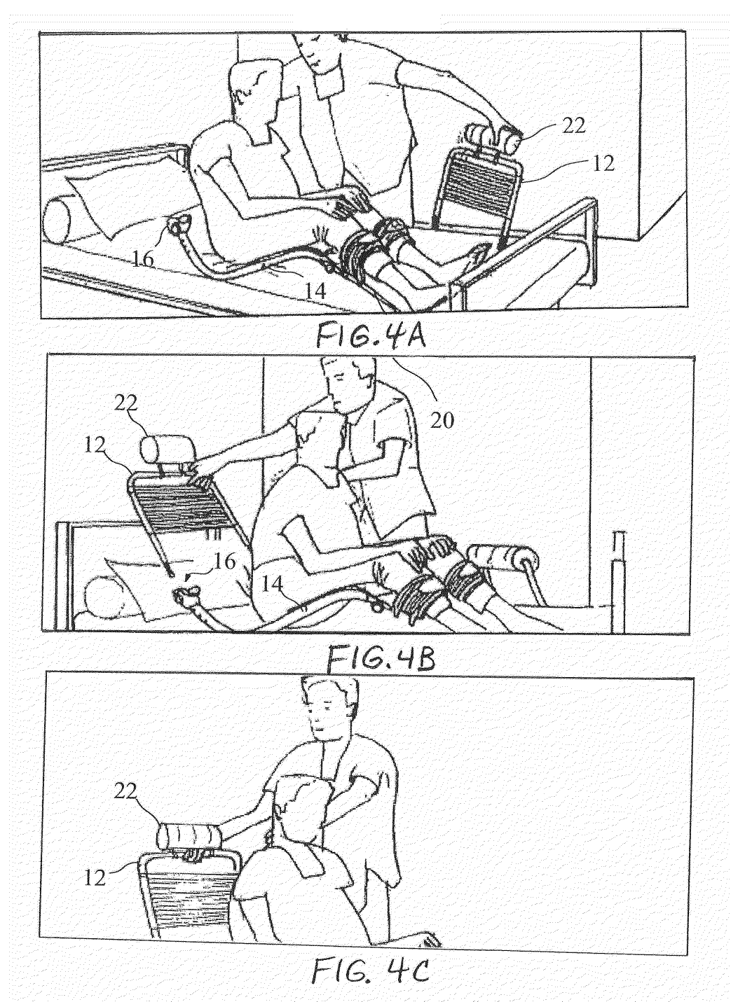

As shown in FIGS. 2A-2C, 3A-3C, 4A-4C, 5A-5C, 6A-6C, the two-piece frame 10 allows the frame to be positioned under the patient by a single assistant without necessitating the assistant to lift the patient completely from the bed or necessitating the assistant to roll the patient to his or her side. As shown in FIGS. 2A-2C, a first step in the process of positioning the frame on the patient is to first lift the patient's legs and then insert the lower thigh support component 14 beneath the patient's legs. As shown in FIGS. 3A-3C, the legs are then strapped to this lower thigh support component 14. The next step as shown in FIGS. 4A-4C of the attached drawings, is to lift the patient's head or back and then position the upper back support portion 12 therebehind coupling it to the lower thigh support portion 14 at the coupling 16. It will be appreciated that adjustable hospital beds may provide a lift-able back support to assist with lifting the patient's back, if desired. As shown in FIGS. 5A-5C, the patient is then strapped to the rigid assembled frame 10.

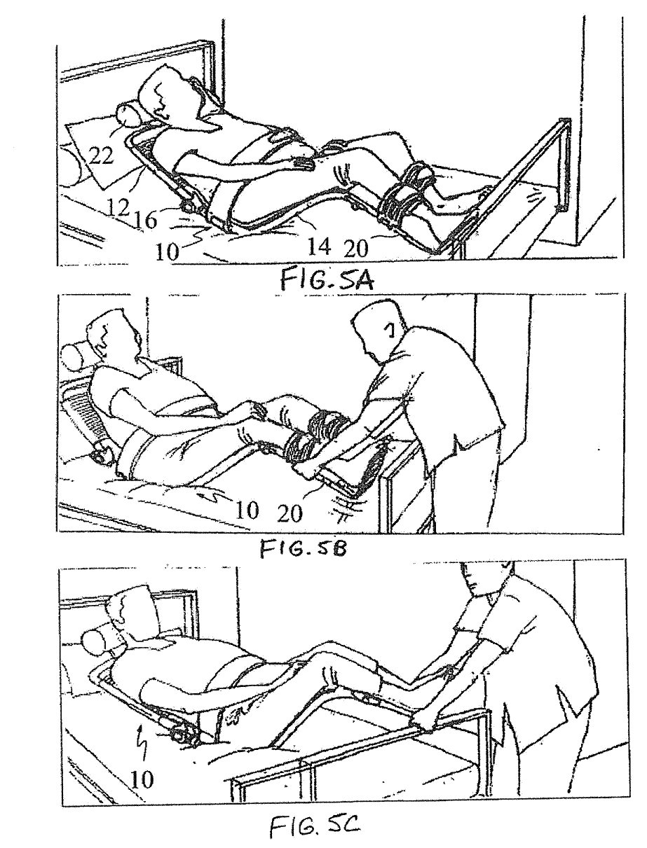

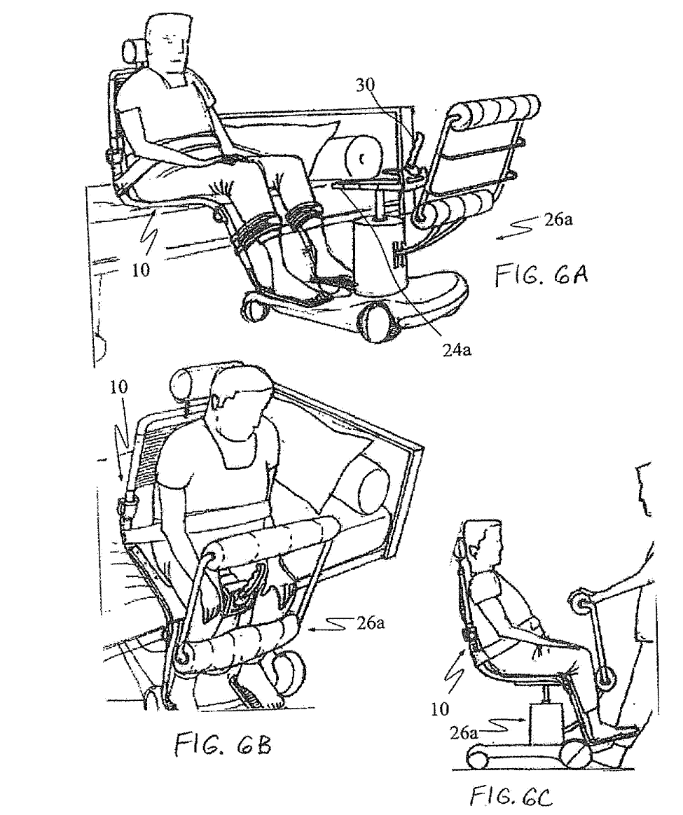

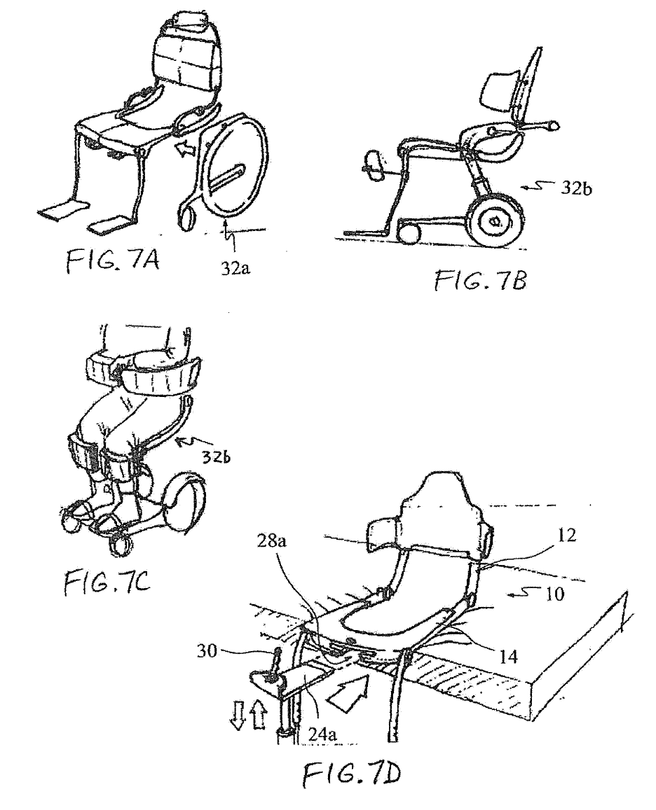

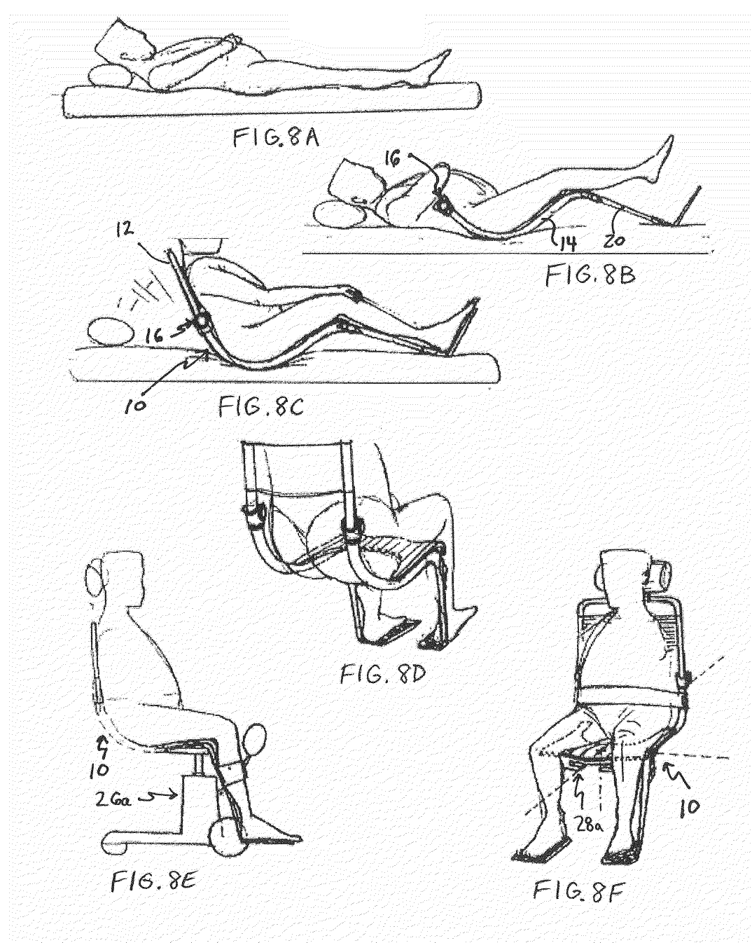

As shown in FIGS. 6A-6C, once the patient is strapped to the rigid, assembled frame 10, a tine 24a of a lift cart 26a will mate with an associated receptacle 28a (See also FIGS. 7D and 8F, for example), so as to lift the patient from the bed and move the patient to the desired location or activity. The lift cart 26b shown FIG. IF is a lateral-access device specialized for transferring the patient bed-to-bed. This dual tines 24b of this lift cart 26b are received within a corresponding pair of hollow-spaces/receptacles 28b, which are respectively formed by the frame 10 between the back support portion 12 of the frame and the bed and between the thigh support portion 14 and the bed. The lift cart 26a shown in FIGS. 2A-2C, 3A-3C, 6A-6C, 7D, 8E-8F is a front access lift device for lifting the patient in a sitting position. The single, centered tine 24a of this lift cart 26a is received within a corresponding hollow-space/receptacle 28a provided by the thigh support portion 14 of the frame, between the legs of the patient.

As shown in FIGS. 1A-1F, the assembled frame 10 has hinges such as the hip hinge 18 and the knee hinge 29 for respective articulation at the hip joint and knee joint for example to allow the subject to change body position to suit the desired activity.

As shown in FIGS. 7A-7C, the first exemplary embodiments may also utilize accessories such as a mobility base 32a/b that can be coupled to the frame 10 so that the frame can act as a wheelchair for example.

Preferably, the tine 24a/b of the lift cart 26a/b engages with the receptacle 28a/b of the frame 10 automatically locks when engaged. A lever 30 may be provided, for example, (see FIG. 7D) to release the lock when necessary.

FIGS. 9A-9F depict a patient transfer system with an associated two-piece patient support frame and lift cart according to second exemplary embodiments of the present invention. The second exemplary embodiments are also designed specifically to assist Category 2 patients. The exemplary embodiment of FIGS. 9A-9F provides a two-piece patient support frame 36 for providing rigid support to a patient's body to facilitate transfers of the patient bed-to-bed or bed-to-chair, etc. The frame 36 includes detachable back-rest pad component 38 and a rigid frame component 40. The back-rest pad component 38 is adapted to be extended between, and attached across a pair of vertically extending, rigid, outer bars 42 of an upper, back portion 44 of the frame 36, which is attached to a lower thigh-support portion 46 of the frame 36 at a hinge articulation point 48. Optionally, the lower thigh support portion 46 may also include heel and foot support components (not shown) extending therefrom (including an articulating knee hinge) while the upper back portion 44 of the frame 36 may optionally include a head supporting component 50. It is within the scope of the invention that the upper back portion 44 of the frame is selectively detachable/re-attachable to the lower thigh-support portion 46 of the frame as described in the first exemplary embodiments (shown in FIGS. 1A-1F, 2A-2C, 3A-3C, 4A-4C, 5A-5C, 6A-6C, 7A-7D, 8A-8F).

To don the frame to the patient, (1) the back-rest pad component 38 is first laid on the mattress beneath the shoulders and back of the patient such the opposed pair of flaps 52 extend laterally out from below the patient's shoulders as shown in FIG. 9A (2) The thigh-support portion 46 of the frame 36 is then laid beneath the thighs of the patient such that the upper back portion 44 of the frame 36 extends above the patient as shown in FIG. 9B. (3) The patient's back is then lifted (with the assistance of the adjustable bed, for example) through the upper back portion 44 of the frame, such that the flaps 52 of the back-rest pad component 38 can be attached to the vertically extending outer bars 42 as shown in FIGS. 9C and 9D. Once the frame is thus assembled, the patient is then strapped to the frame 36.

To manipulate the patient and frame to the seated position with the patient's legs dangling over the side of the bed (so that the frame can be coupled to a lift cart 26c at the side of the bed): the bed is adjusted back to its flat configuration again, where the weight of the patient's upper body causes the back portion 44 to lay flat on the bed and the thigh portion 46 to extend upwardly (this is not shown in FIG. 9); next, (4) the patient is turned on his/her side such that his/her legs extend over the side of the bed as shown in FIG. 9E; and, finally, (5) the adjustable bed is used again to help flip up the back portion 44 such that the patient is flipped to the seated position with his/her legs dangling over the side of the bed as shown in FIG. 9F.

The thigh-support portion (seat) 46 of the frame 36 includes forward and side receptacles (hollow spaces) 54a/b for receiving and being coupled to a tine 24c of a corresponding lift cart 26c in a manner as described above.

Referring to FIGS. 38A-38E, the back-rest pad component 38 (or any of the other lifting or support belts, straps or webbing described herein and adapted to be releasably secured behind the patient to one of the exemplary frames, pallets, seats or otherwise) can be initially attached or secured to the bed mattress or the bed frame. For example, as shown in FIG. 38C, the back-rest pad component 38 is secured to the bed frame 55 by hooks 57 extending from the bed frame which are received within eyelets 59 extending through the lateral ends of the back-rest pad component 38. As another example, as shown in FIG. 38D, the back-rest pad component 38 is secured to the bed frame 55 by a buckle component 61 having a lever 63 that opens and closes the buckle 61 onto the lateral ends of the back-rest pad component 38.

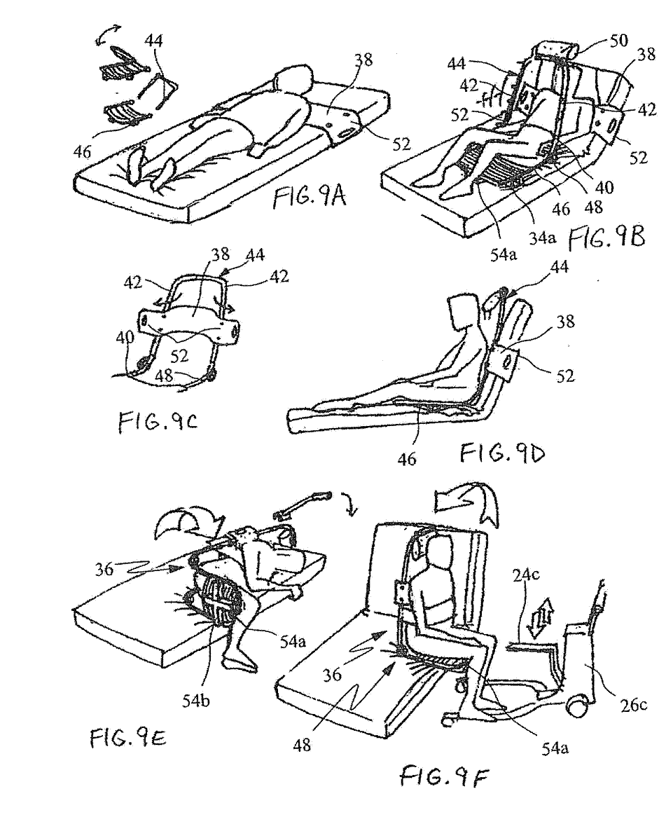

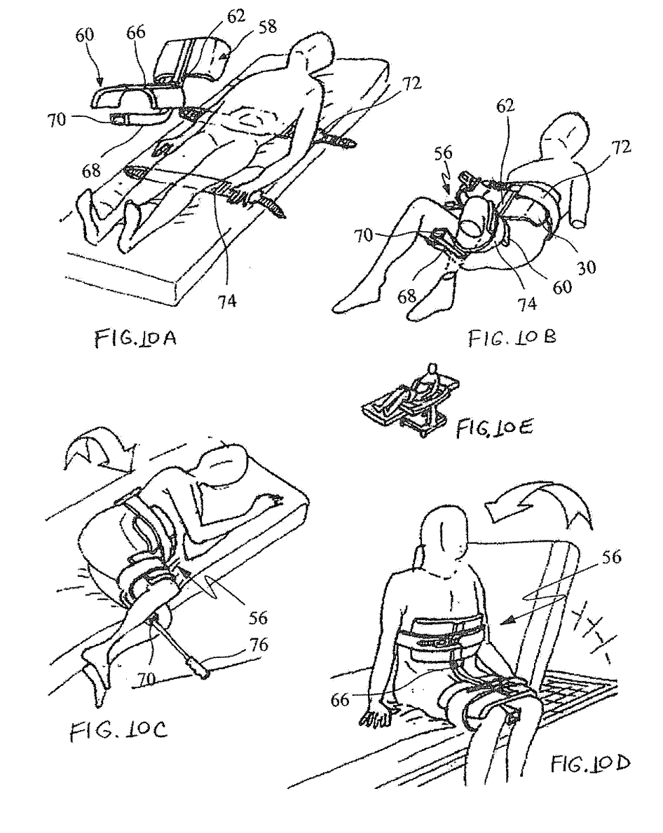

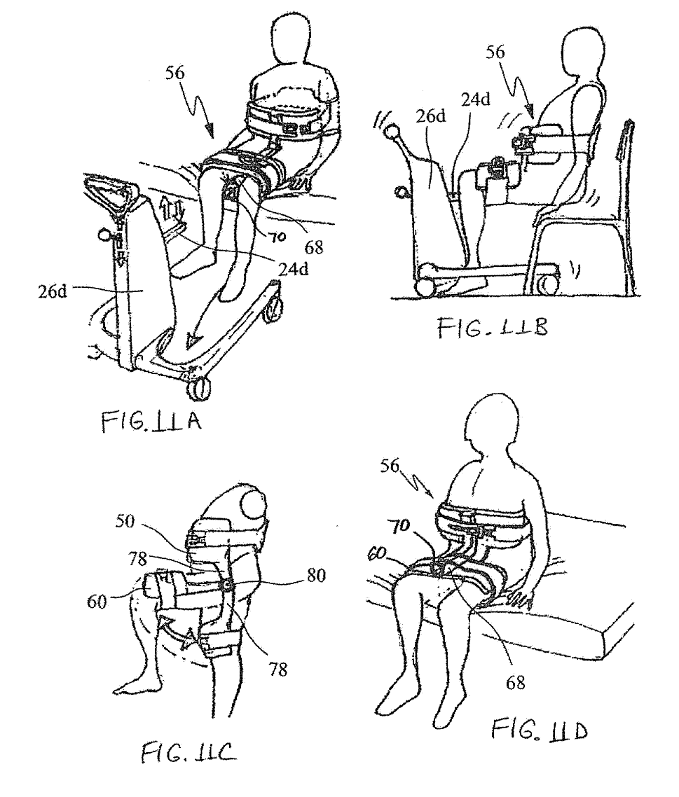

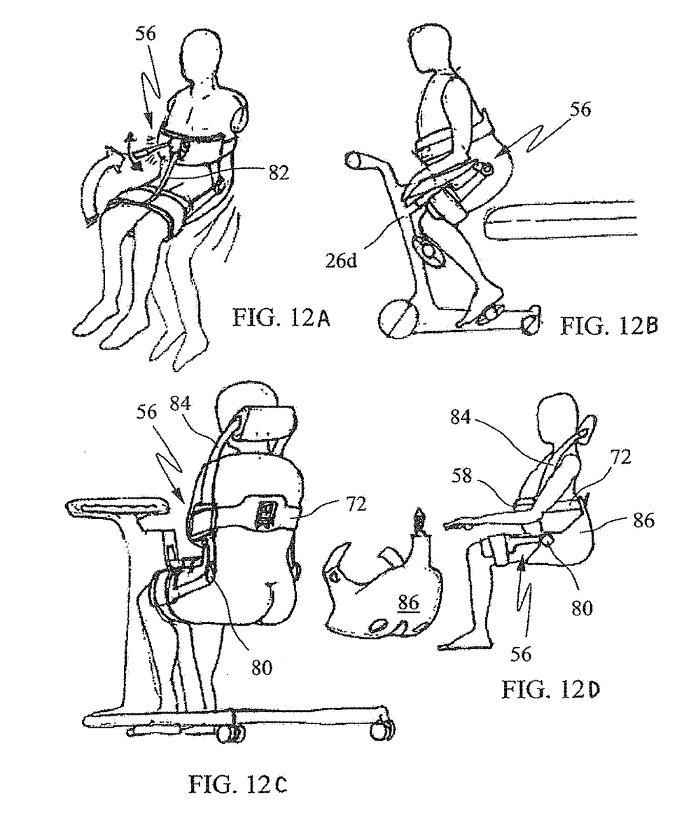

FIGS. 10A-10D, 11A-11D, 12A-12D depict a patient transfer system with an associated multi-piece patient support frame and lift cart according to third exemplary embodiments of the present invention. The third exemplary embodiments are designed specifically to assist Category 2 patients. The support frame 56 of the third exemplary embodiments include frontal waist plate 58 and a frontal thigh plate 60, each of which include respective central bars 62/64 respectively extending downward and upwardly therefrom and connected together at an articulating hinge 66. The downward extending bar 62 also includes an extension 68 that is adapted to extend forwardly between the legs of the patient and this includes a receptacle 70 at an end thereof for receiving and being coupled to a tine 24d of a lift cart 26d (see FIGS. 11A-11D, 12A-12D). The support frame 56 of the third exemplary embodiments also includes an upper-body belt 72 and a thigh belt 74, each of which are adapted to lie on the bed between the patient and the bed and to be respectively strapped to the frontal waist plate 58 and frontal thigh plate 60, respectively as shown in FIGS. 10A and 10B.

To manipulate the patient and frame to the seated position with the patient's legs dangling over the side of the bed (so that the frame can be coupled to a lift cart 26d at the side of the bed): after strapping the frame 56 about the patient as described above, the patient is turned on his/her side such that his/her legs extend over the side of the bed (a lever 76 received within the receptacle 70 may assist with this step) as shown in FIG. 10C; and, next, the adjustable bed is used to help flip up the patient to the seated position with his/her legs dangling over the side of the bed as shown in FIG. 10D.

As shown in FIGS. 11A and 11B, the lift cart 26d includes a tine 24d that is coupled to the receptacle 70, allowing the patient to be easily transported from the bed. As shown in FIGS. 11A and 11D, the extension 68 may extend both above or below the frontal thigh plate 60. As also shown in FIG. 11C, it is within the scope of the invention to couple the frontal thigh plate 60 to the upper waist plate 58 with opposing pairs of side bars 78, each pair of which is coupled at a hip hinge 80.

FIGS. 12A-12D illustrate various adaptations of, and accessories for use with the third exemplary embodiments. FIG. 12B illustrates that the patient may be received by the lift cart 26d in a kneeling-seating posture. FIG. 12A illustrates an accessory that provides an articulating lever/sling assembly 82 to assist with articulating the patient's legs with respect to his/her waist. FIGS. 12C and 12D illustrate an accessory that provides a neck and head support component 84 that may be coupled to the upper waist plate 58 to extend behind the patient's neck and head. FIGS. 12C and 12D also illustrate an accessory that provides a bottom/seat support 86, which may be attachable to the hip hinges 80 and the body belt 72 (the bottom/seat support 86 may also include openings for communication with a human-waste receptacle or tank).

FIGS. 13A-13E depict a patient transfer system with an associated patient support palette and lift cart according to a fourth exemplary embodiment of the present invention. The fourth exemplary embodiment is designed specifically to assist Category 1 patients. As shown in FIGS. 13A-13E, the fourth exemplary embodiment is essentially a rigid seat 88, which includes a front-central receptacle 90 (positioned between the legs of the seated patient) adapted to couple the seat 88 to a tine 24e of a lift cart 26e.

FIGS. 14A-14C, 15A-15G depict a patient transfer system with an associated patient support frame and lift cart according to fifth exemplary embodiments of the present invention. The fifth exemplary embodiments are designed specifically to assist Category 3 patients. Similar to the frame of the first exemplary embodiments (See FIGS. 1A-1F, 2A-2C, 3A-3C, 4A-4C, 5A-5C, 6A-6C, 7A-7D, 8A-8F), the frame 92 of the fifth exemplary embodiment includes a back/head-support segment 93 attached at a hip-hinge 94 to a thigh-support segment 96, which is attached by a knee hinge 98 to a shin/foot-support segment 100. The lift cart 26f shown FIGS. 14A-14C, 15B-15F is a lateral-access device specialized for transferring the patient bed-to-bed. This dual tines 24f of this lift cart 26f are received within a corresponding pair of hollow-spaces/receptacles 102, which are respectively formed by inflatable jacks 104 between the three segments 93, 96 and 100, and the bed. As shown in FIGS. 14A-14B, the dual tines 24f are preferably adjustable in height and orientation, so as to coordinate with the hinges 94 and 98 of the frame 92 to manipulate the patient between a flat position and a sitting position, for example. As also, shown in FIG. 14A, a lever 106 may be provided to assist in lifting the back/head-support segment 93 from the flat position to a sitting position when lying on the bed.

As shown in FIG. 15B, the frame itself may include laterally extending receptacles 108, respectively positioned at the hinges 94 and 98, for receiving the tines 24f of the lift cart 26f. As also shown in FIGS. 15A and 15E, the frame includes an opening 110 approximate the buttocks area to allow for human waste to pass therethrough. In association with this opening 110, the lift cart 26f may include an under-buttocks support panel 112 that pivots to cover the opening 110 during transport of the patient, and the system may also utilize a disposable waste receptacle 114 that may be coupled below the opening 110.

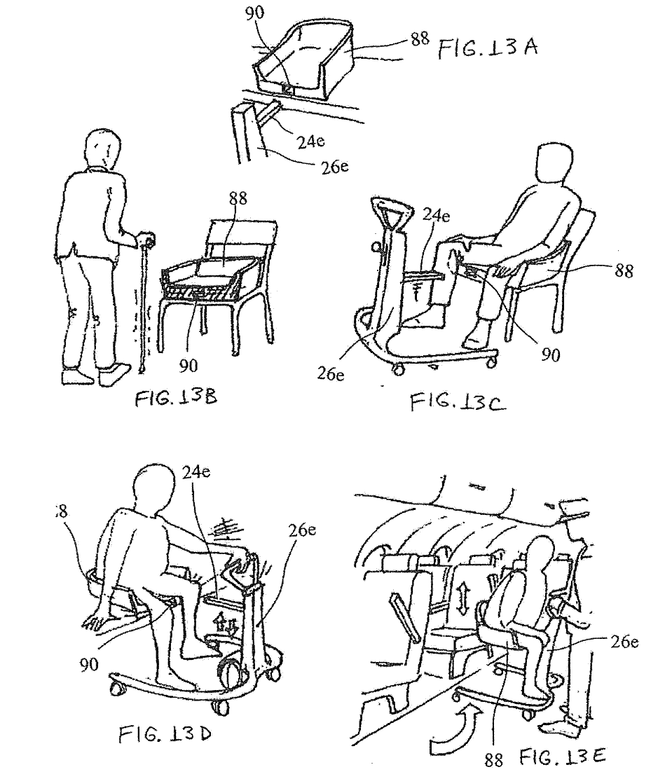

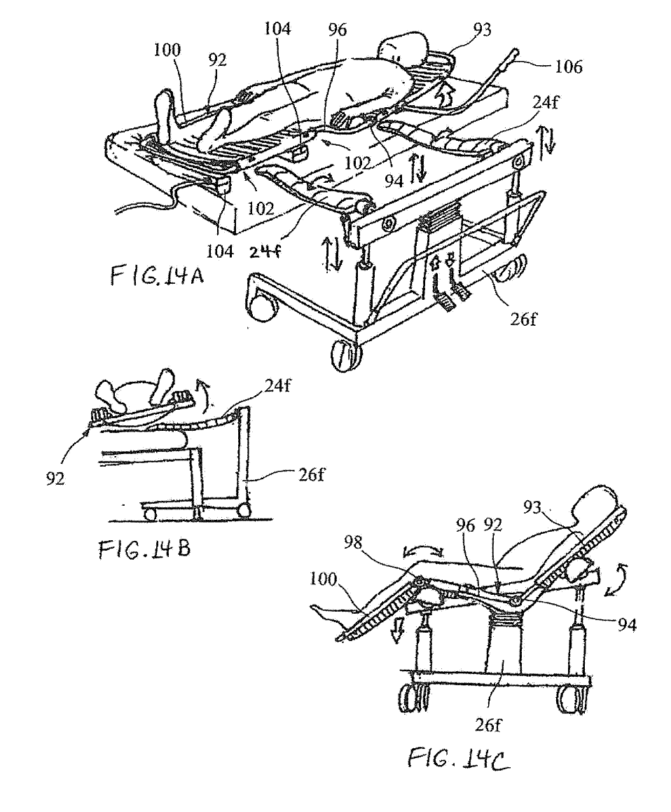

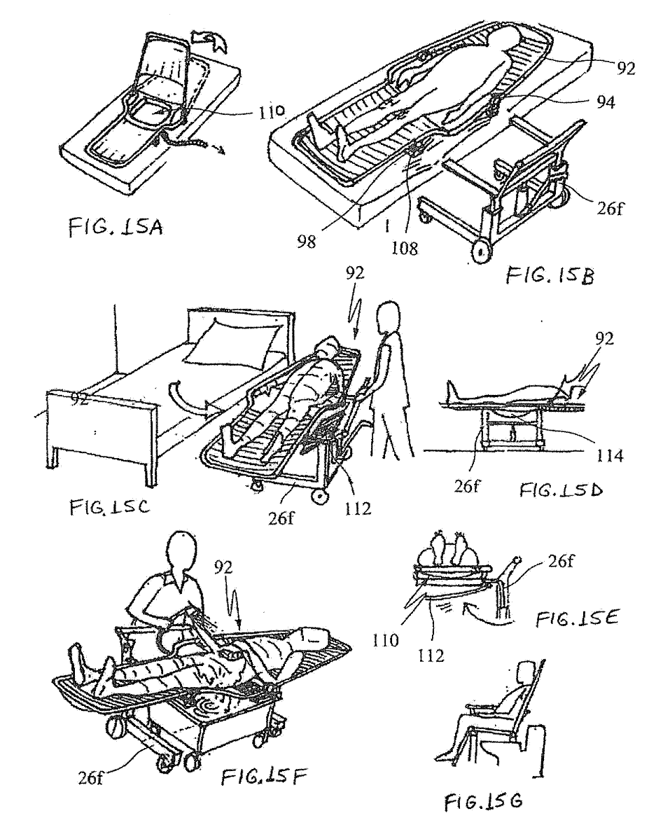

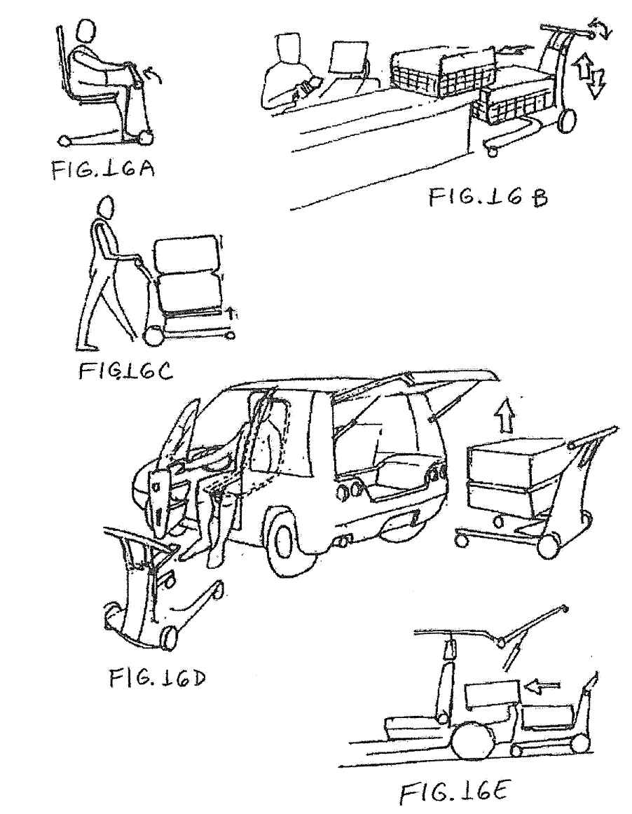

FIGS. 16A-16E illustrates how the lift cart may be useful to transport a patient, for example, to his/her automobile and then may be used to load other objects/cargo into the automobile.

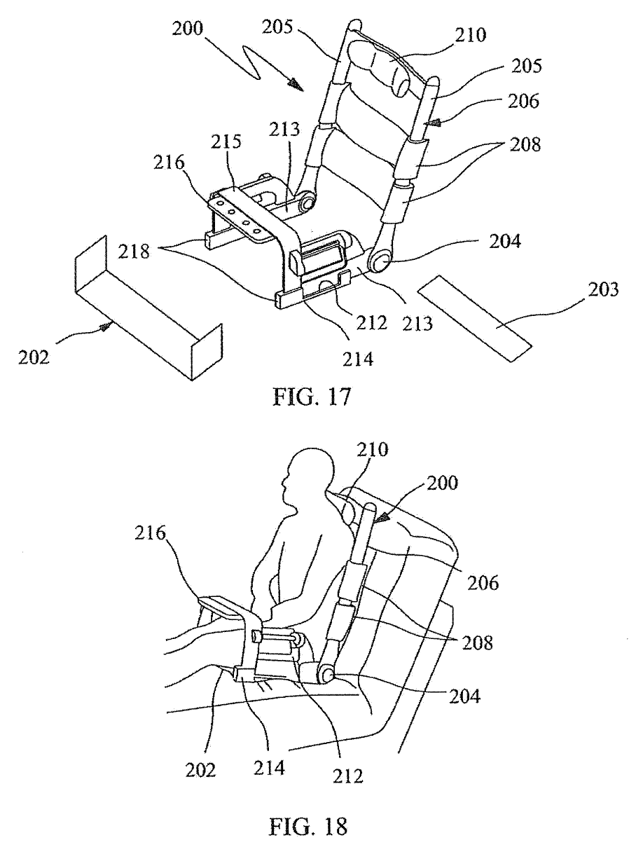

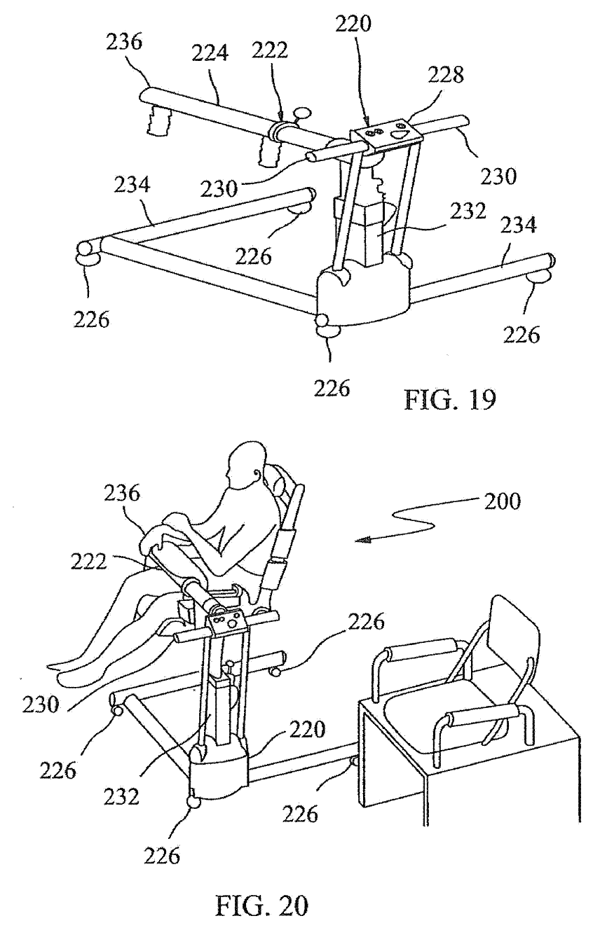

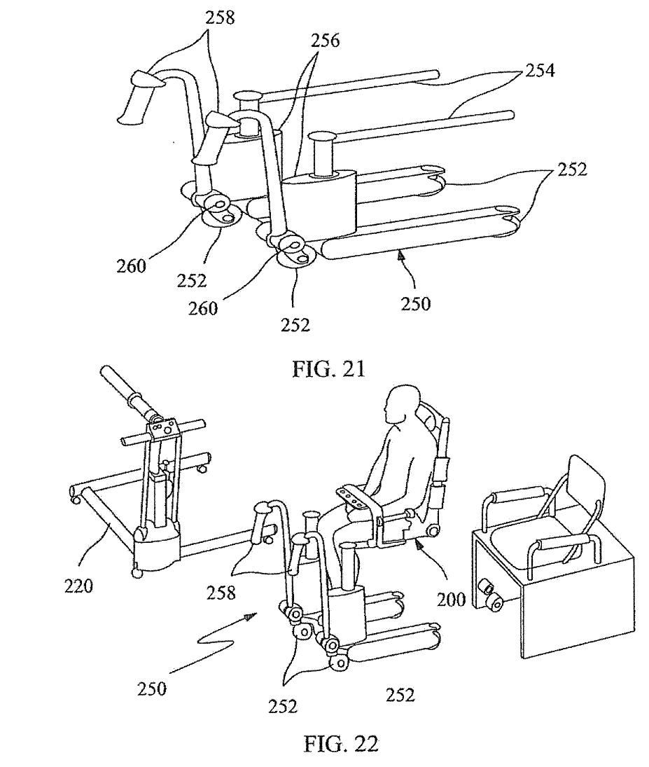

Another exemplary embodiment of the system is shown in FIGS. 17-24. FIG. 17 shows a frame assembly 200 that is comprised of an upper frame 206 and a lower frame 214 connected with an articulated joint 204. The upper frame 206 includes a pair of rigid vertical bars 205 and at least one rigid cross-bar 207 extending therebetween. The lower frame 214 includes a pair or rigid vertical bars 213 and at least one rigid cross-bar 215 extending therebetween. In this embodiment, the pair of rigid vertical bars 213 of the lower frame 214 are adapted to extend along the back and sides of a patient's thighs, while the cross-bar 215 extending therebetween is substantially u-shaped so as to be adapted to curve over the top of the patient's thighs. Lateral ends of under-thigh strap 202 are adapted to be coupled to corresponding attachment points 212 on the vertical bars 213 of the lower frame 214. The articulated joint 204 is located proximate to the patient's hip when the frame assembly 200 is in use. Back support webbing or straps 208 are mounted between the rigid vertical bars 205 of the upper frame 206 and a shoulder/neck support pad/cushion 210 is mounted on the rigid cross-bar 207 of the upper frame 206. Attachment coupling 216 in the form of a forwardly extending shelf, extending from the rigid cross-bard 215 of the lower frame 214 is designed to mate with a corresponding attachment coupling 224 on the lateral bed extractor 220 shown in FIG. 19. The lower frame 214 also includes forwardly extending receptacles 218 (extending into the vertically extending bars 213) for a different cart unit's 250 forks 254 as shown in FIG. 21. Complementary strap 203 can optionally be attached to lower frame 214 to provide additional support for a patient's buttocks.

FIG. 18 shows a patient in a sitting position with the frame assembly 200 donned thereon. To don this frame assembly 200, the under-thigh strap 202 extends under the patient's thighs and is attached at the attachment points 212 on the lower frame 214. The articulated joint 204 can be articulated to set the necessary angle between the lower frame 214 and the upper frame 206 so that the patient is supported by the under-thigh strap 202, the back supports 208, and the shoulder/neck support 210.

The frame assembly 200 is used by positioning the upper frame 206 behind the patient's back and the lower frame 214 around the patient's thighs. The under-thigh strap 202 previously placed on the bed under the patient's thighs and attached to the lower frame 214 at attachment points 212.

FIG. 19 shows the lateral bed extractor 220. The lateral bed extractor 220 includes a horizontal arm 236 with an integral attachment coupling 224 and locking mechanism 222 for attaching to the chair unit 200 at attachment coupling 216 as shown in FIGS. 17 and 18. The horizontal arm 236 is supported by a powered lift unit 232, which manipulates the horizontal arm 236. The extractor 220 is operated from the control panel 228 and can be moved using the handles 230. The lift mechanism 232 is supported from the floor on wheels 226 and a base unit 234. The lift unit 232 can be operated hydraulically, pneumatically, by a motorized mechanism, manually, or by any other means capable of raising and lowering (or other manipulations of ) the horizontal arm 236.

FIG. 20 shows the lateral bed extractor 220 coupled with the frame assembly 200 holding a patient. In this configuration, the patient can be raised from or lowered to a bed or chair or be moved by rolling the lateral extractor 220 on its wheels 226.

The lateral bed extractor 220 is used by moving it adjacent to a patient attached to the frame assembly 200 and coupling the integral attachment coupling 224 with the frame assembly 200 attachment coupling 216. It may be necessary to raise or lower the horizontal arm 236 using the lift unit 232 to allow the attachment couplings 224 and 216 to interact properly. The attachment couplings 224 and 216 are locked together using the locking mechanism 222 and the patient is lifted using the lift unit 232. The patient is wheeled to the desired location using handles 230. The patient is then lowered to the desired position using the lift unit 232, the locking mechanism 222 is released, the couplings 224 and 216 are decoupled, and the horizontal arm 236 is moved away from the chair unit 200. The patient may remain in the frame assembly 200 or the frame assembly 200 may be removed.

FIG. 21 shows a forward cart unit 250. The cart unit 250 is supported from the floor by wheels 252 and is moved using handles 258. Handles 258 pivot at joints 260. Forks 254 extend horizontally and are designed to couple with the forwardly extending receptacles 218 on the frame assembly 200 shown in FIG. 18. Lift units 256 raise and lower the forks 254. The lift units 256 can be operated hydraulically, pneumatically, by a motorized mechanism, manually, or by any other means capable of raising and lowering the forks 254.

FIG. 22 shows the cart unit 250 holding a frame assembly 200 with a patient. The cart unit 250 can be moved using handles 258 and wheels 252.

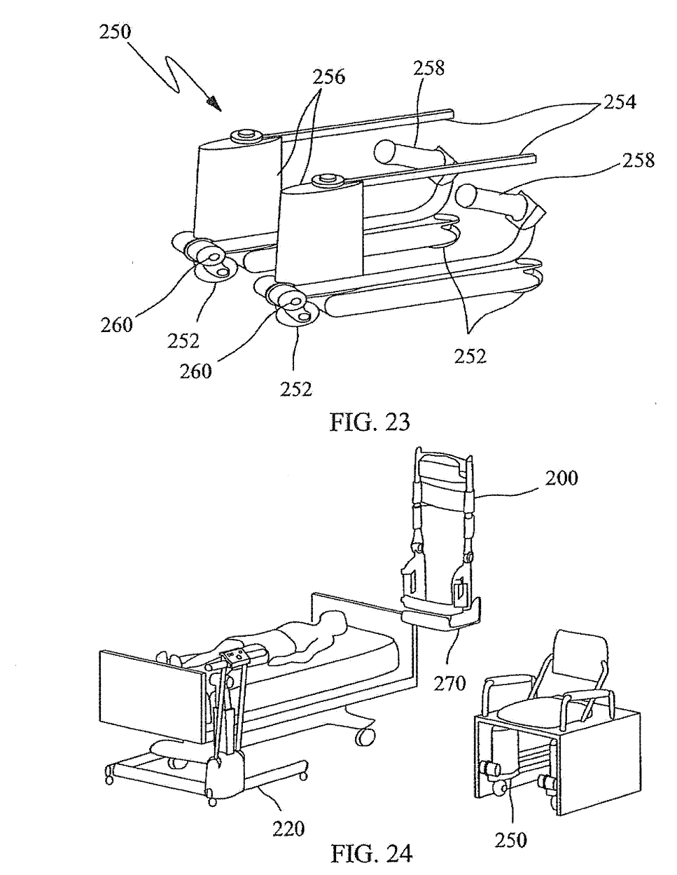

FIG. 23 shows cart unit 250 in its collapsed configuration. Handles 258 are folded down and lift units 256 are fully lowered to reduce the height of the forks 254. The chair unit can be rolled in this configuration on the wheels 252.

The cart unit 250 is used by first removing it from its storage location. The handles 258 are swung to their vertical position shown in FIG. 21. The forks 254 are raised using the lift mechanisms 256 to the height of the receptacles 218 on the frame assembly 200. The forks 254 are inserted into the receptacles 218 and the lift mechanisms 256 are used to lift the patient. The patient is then moved to the desired destination using the handles 258. The patient may remain on the cart unit 250 or may be deposited in another location by lowering the frame assembly 200 using the lift mechanisms 256 and removing the forks 254 from the receptacles 218.

FIG. 24 shows an exemplary space-saving storage scheme. The frame assembly 200 is stored on a shelf 270 mounted to the wall, the lateral extractor 220 is stored near the foot of the patient's bed, and the cart unit 250 is stored beneath a chair.

In a further embodiment of the invention, the frame assembly 200 is used by the patient on other carts, wheelchairs, scooters, motor vehicles, etc.

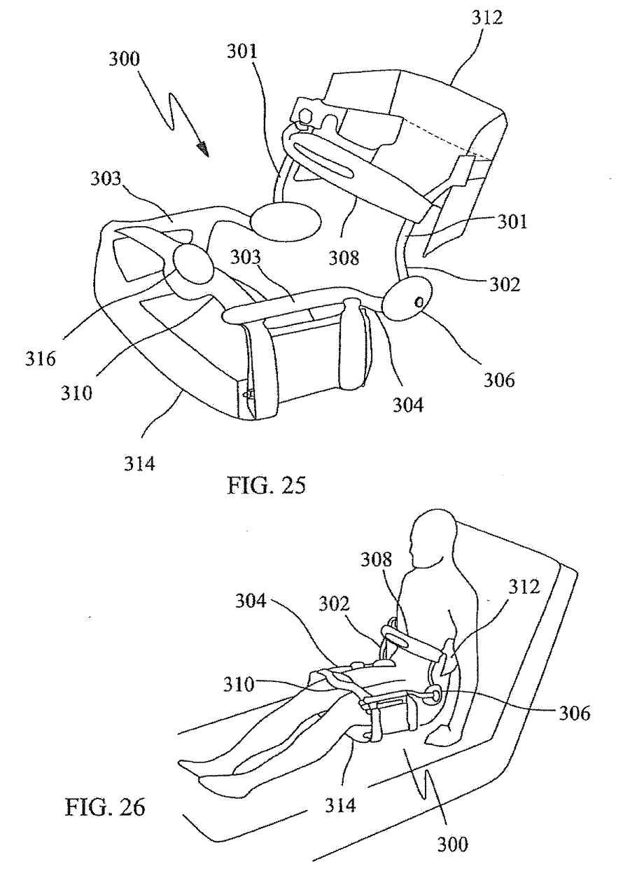

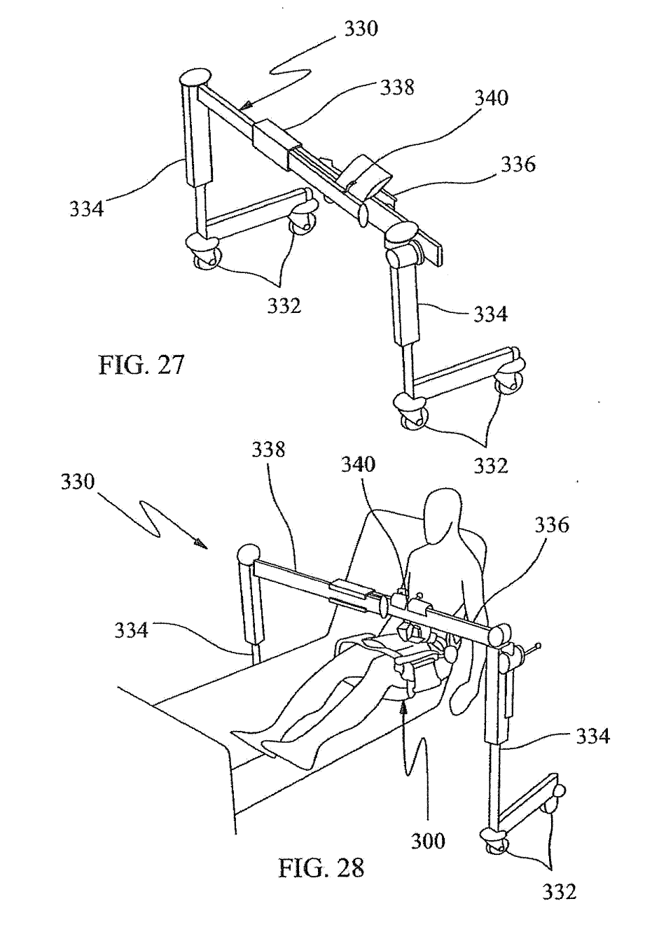

Another exemplary embodiment of the invention is shown in FIGS. 25-30. FIG. 25 shows frame assembly 300 which is comprised of an upper frame 302 and a lower frame 304 connected by an articulated joint 306. The upper frame 302 includes an opposed pair of vertically extending rigid bars 301 and a rigid cross-bar 308 extending therebetween, which is adapted to extend across a patient's chest. The vertically extending rigid bars 301 are curved and include an upper rearwardly facing upper end (which extends to the patient's back) to which a back strap 312 extends laterally therebetween. The lower frame 304 includes a pair of vertically extending rigid bars 303 and a rigid cross-bar 310 extending therebetween, which is adapted to extend across the patient's thighs. A pair of rigid arms extend rearwardly (to the back of the patient's thighs) from each of the vertically extending rigid bars 303, where each pair of rigid arms are coupled to a respective lateral end of a thigh strap 314. The back strap 312 and the thigh strap 314 are made of flexible materials (such as fabric). The cross-bar 310 includes an attachment coupling 316 that is of a complementary design to couple to the attachment mechanism 336 on the extensible bed extractor shown in FIG. 27.

FIG. 26 shows the frame 300 donned to a patient. To don the frame 300, the back strap 312 and the thigh strap 314 are placed behind the patient's back and under the patient's legs, respectively; or are previously placed on the bed before the patient (desirably while the bed is raised to the sitting position shown in FIG. 26). The rigid components of the frame 300 are then placed on the patient as shown. The back strap 312 and thigh strap 314 are then reattached as shown. If necessary, the angle between the upper frame 302 and the lower frame 304 can be adjusted by articulating the joint 306.

FIG. 27 shows the extensible bed extractor 330 which comprises a horizontal member 338 and two lift units 334 supported from the floor on wheels 332. The horizontal member 338 can be laterally extended and collapsed. Mounted to the horizontal member 338 is an attachment mechanism 336 with a locking mechanism 340. The attachment mechanism 336 can be moved along the horizontal member 338. The lift units 334 can be operated hydraulically, pneumatically, by a motorized mechanism, manually, or by any other means capable of raising and lowering the horizontal member 338.

FIG. 28 shows the extensible bed extractor 330 attached to the frame assembly 300 containing a patient. To use the extensible bed extractor 330, the patient is first placed into the frame assembly 300 as described above. The extensible bed extractor 330 is maneuvered near the patient such that the attachment coupling 316 on the frame assembly 300 can be coupled with the attachment mechanism 336 of the extensible bed extractor 330. The attachment mechanism 336 is locked using the locking mechanism 340. The patient is lifted using the lift units 334. The horizontal member 338 is extended and the patient is moved horizontally by sliding the attachment mechanism 336 along the horizontal member 338. The patient is moved to a position above the desired destination (e.g., a chair, wheelchair, scooter, commode, etc.). The patient is then lowered using the lift units 334, the locking mechanism 340 is released, and the attachment coupling 316 is removed from the attachment mechanism 336. The extensible bed extractor 330 can then be moved away and the horizontal member 336 collapsed if desired.

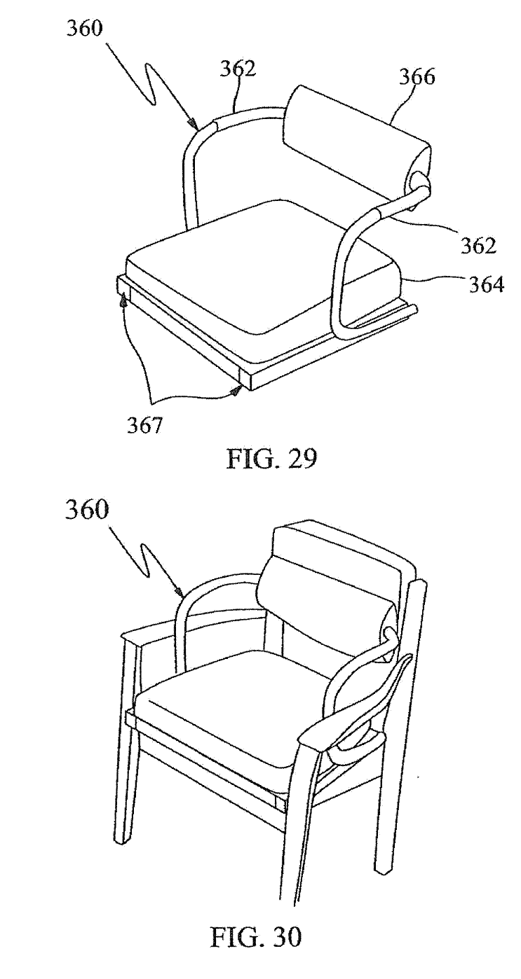

FIG. 29 shows a pallet 360 which is essentially in the form of a leg-less chair that includes a back support 366, arms 362, a seat 364, and receptacles 367 designed to mate with the forks 254 of the cart unit 250 (FIG. 23).

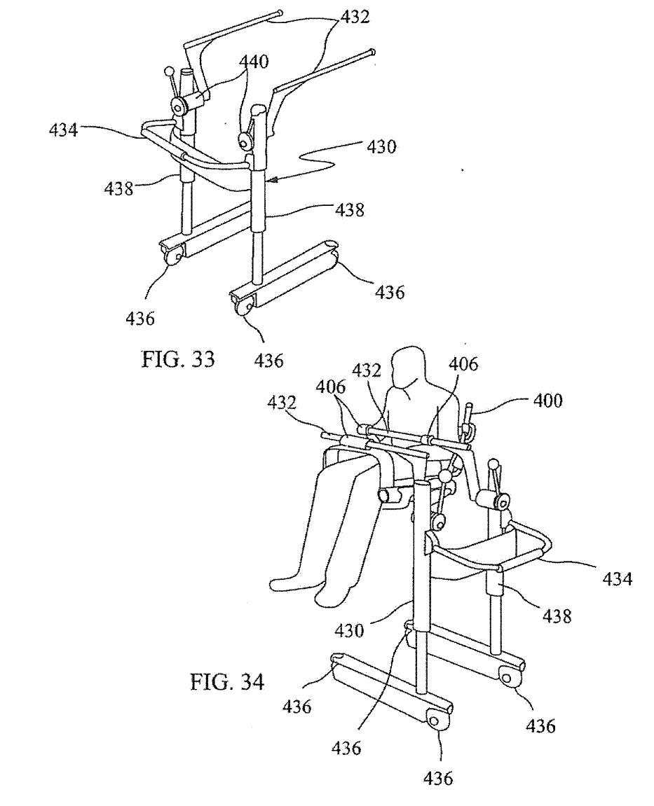

The pallet 360 is used to transport a patient with a cart unit 250 or rotating fork cart 430 (FIG. 33). The patient is placed on or removed from the pallet 360 using a frame assembly 200 or a frame assembly 300 with a lateral bed extractor 220 or extensible bed extractor 330, respectively. In a further embodiment of the invention, pallet 360 is used by the patient on other carts, wheelchairs, scooters, motor vehicles, etc.

FIG. 30 shows a pallet 360 placed on a chair ready to receive a patient.

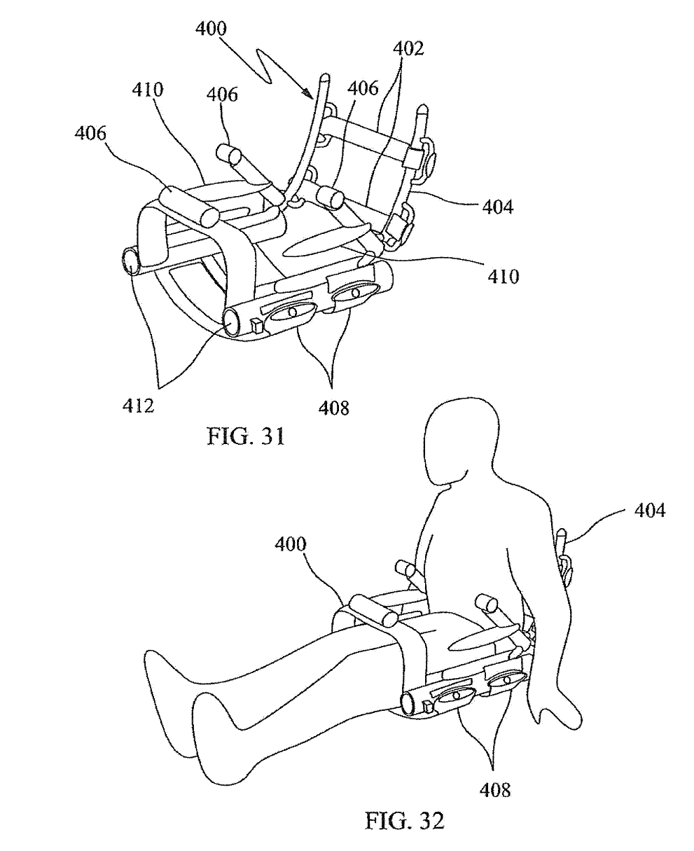

Another exemplary embodiment of the system is shown in FIGS. 31-37. FIG. 31 shows a frame assembly 400 that includes a rigid frame 404 that comprises a pair of opposed curved vertical bars, where the upper portions of the bars extend vertically along a patient's back and the lower portions of the bars extend vertically along a patient's thighs. Back support webbing or straps 402 extend laterally across the upper portions of the opposed curved vertical bars, removable thigh webbing or straps 408 extend laterally across the lower portions of the opposed curved vertical bars. Arm rests 410 extend forwardly from each of the opposed curved vertical bars. Lateral receptacles 406 for the forks 432 of the rotating fork cart 430 are provided in the structural supports for the arm rests 410, and another lateral receptacle 406 is provided in a u-shaped lateral bar extending between the lower portions of the opposed curved vertical bars (and over the patient's thighs). Front receptacles 412 also designed to receive the forks 432 of the rotating fork cart 430 are provided in the lower ends of the opposed curved vertical bars.

FIG. 32 shows the frame assembly 400 in place on a patient. The thigh straps 408 are attached to the frame 404 under the patient's thighs such that they will support the patient when the seat unit 400 is lifted. The frame assembly 400 is used by detaching the thigh straps 408 and placing it around the patient as shown. The thigh straps 408 are then placed under the patient's thighs and attached to the frame 404.

FIG. 33 shows a rotating fork cart 430 which includes forks 432 which can rotate when the locking mechanisms 440 are released. The forks 432 can be raised and lowered using the lift mechanisms 438 which are supported from the floor by wheels 436. The lift mechanisms 438 can be operated hydraulically, pneumatically, by a motorized mechanism, manually, or by any other means capable of raising and lowering the forks 432. The rotating fork cart 430 is moved using the handle 434. In this figure, the forks 432 are in their upper position which is used when a patient is to be moved to or from a bed using a frame assembly 400.

FIG. 34 shows a rotating fork cart 430 holding a patient who is fastened within a frame assembly 400. The forks 432 of the rotating fork cart 430 are mated with the lateral receptacles 406 of the frame assembly 400. The patient can be transported by using the handle 434 to push the rotating fork cart 430 on its wheels 436.

The rotating fork cart 430 is used by first placing the patient in a frame assembly 400 as discussed above. The rotating fork cart's 430 forks 432 are rotated to the upper position. The forks 432 are coupled with the lateral receptacles 406 on the frame assembly 400. The patient is lifted off the bed using the lift mechanisms 438. The rotating fork cart 430 is then moved away from the bed and the patient is placed above the chair, wheelchair, commode, etc. onto which the he or she is to be deposited. The patient is lowered using the lift mechanisms 438.

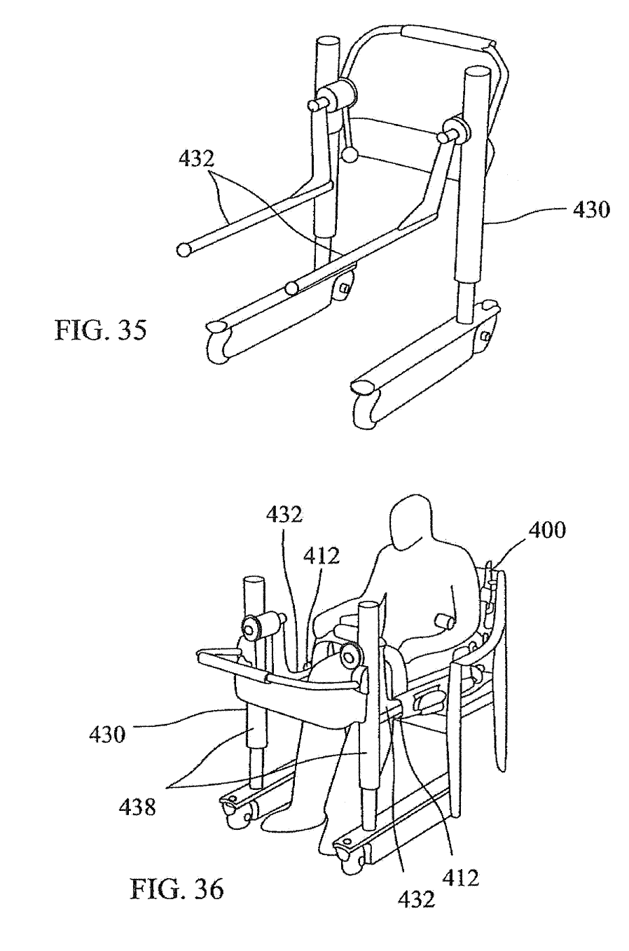

Once the patient is supported by a chair or other support device, the forks 432 are removed from the receptacles 406. The forks 432 can then be moved to their lower position as shown in FIG. 35. This configuration is used when the rotating fork cart 430 is to be stored and when a patient is to be transported using the front receptacles 412 on a frame assembly 400.

As shown in FIG. 36, the forks 432 are inserted into the front receptacles 412 of the frame assembly 400. The patient is lifted using the lift mechanisms 438 and the rotating fork cart 430 and the patient can be moved as necessary. If needed, an additional strap may be attached under the patient's buttocks to disperse his or her body weight.

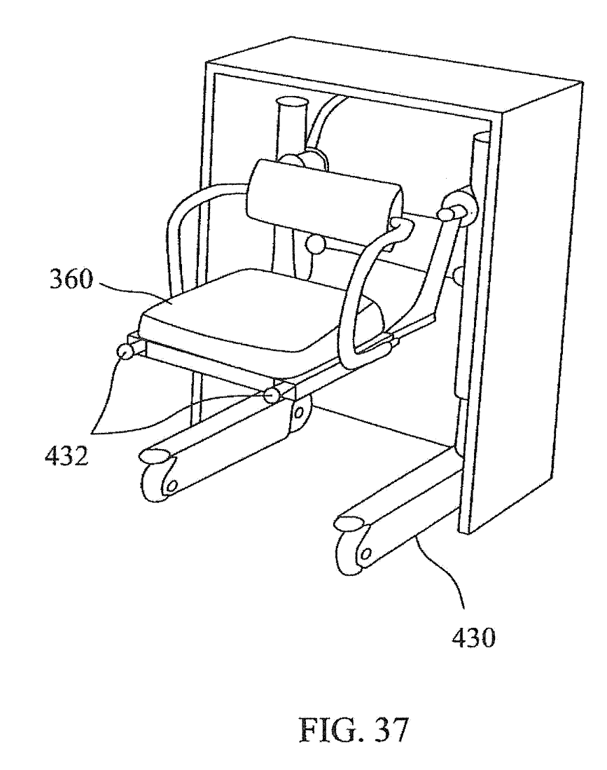

FIG. 37 shows a rotating fork cart 430 with its forks 432 mated with a pallet 360. This configuration can be used for storage and for transporting patients. Additionally, this configuration allows the rotating fork cart 430 and pallet 360 to be used as room furniture when they are not needed for moving a patient.

A further embodiment of the present invention is the use of a frame assembly 200, pallet 360, or similar device as a “persistent interface.” The persistent interface device is used to assist in moving the patient from his or her bed and as a removable seat or equivalent for motorized scooters, wheelchairs, or other devices. For example, a patient is placed in the frame device while in bed. Using the frame device with an extractor, the patient is removed from the bed and placed on a motorized scooter. The frame device also serves as the seat for the scooter. If the patient requires transport in a wheelchair, the frame device serves as the seat for the wheelchair.

The use of a persistent interface device is advantageous for both patients and personnel assisting patients because once a patient is seated in the frame device, he or she does not have to move from seat-to-seat to move from a bed or a chair to a wheelchair or scooter. This results in less stress on patients and health care staff as well as a reduced risk of injury.

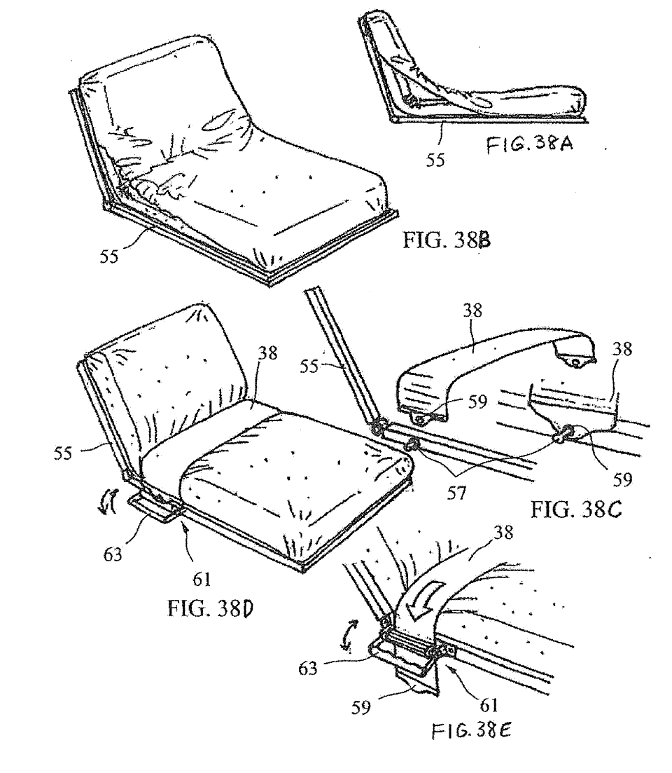

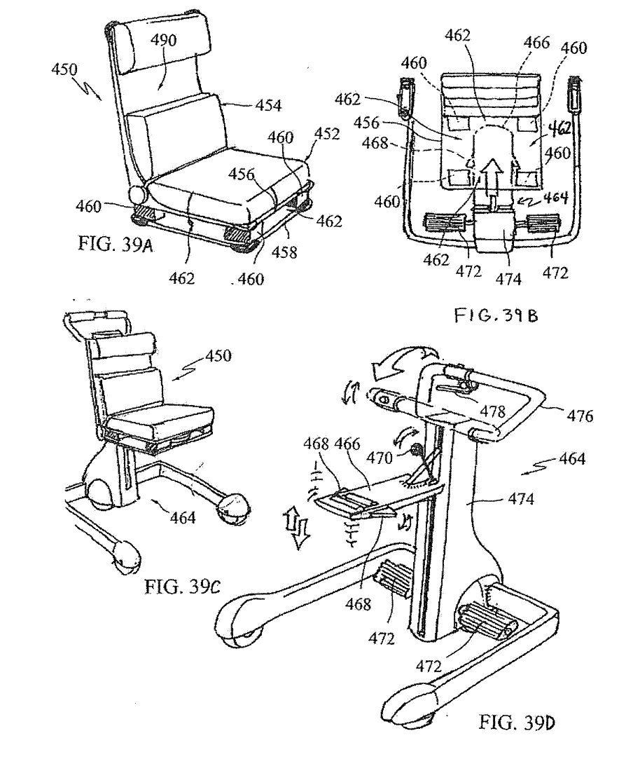

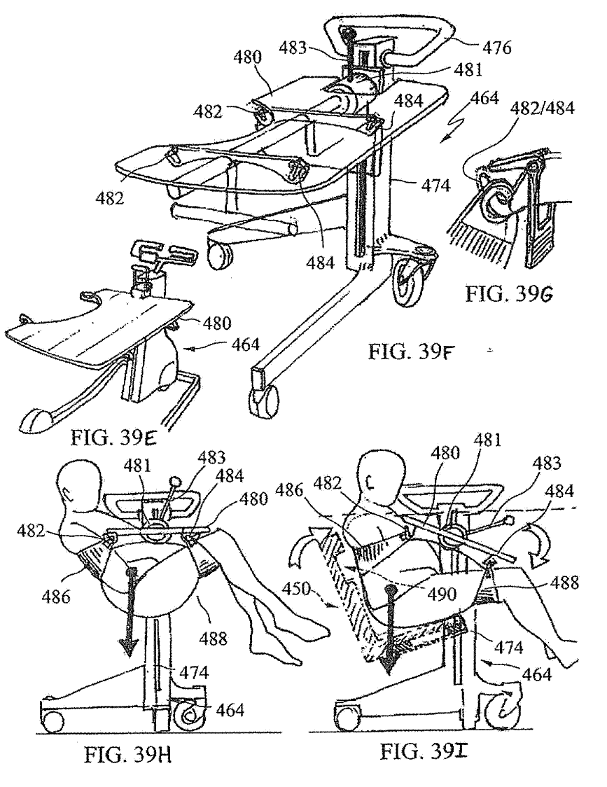

FIGS. 39A-39I depict yet another set of exemplary embodiments according to the present invention. In these embodiments, another type of pallet support 450 is provided, which includes a padded seat portion 452 and a padded back-rest portion 454 extending upwardly from the seat portion 452. The seat portion includes a rigid base comprised of a pair of rectangular, stacked plates 456, 458 separated by four corner blocks 460 (positioned between the comers of the plates). The spaces between the corner blocks provide four identical receptacles 462, respectively facing forward, backward and to each side.

Referring to FIGS. 39B and 39D, the lift cart 464 includes a fork 466 for selectively coupling to one of the receptacles 462. The fork 466 includes a pair of recessable tangs 468 that have a tapered leading edge. The tangs 468 are biased out of the their corresponding recesses and provide the fork 466 with a width that is larger than the width of the receptacle. The tangs 468 are adapted to recess within the recesses as the fork 466 is inserted into the receptacle 462 and the leading edges of the tangs contact the corner blocks 460. Upon passing the corner blocks 460 the tangs 468, which are no longer in contact with the corner blocks, eject out again and provide a safety lock to lock the fork 466 within the receptacle. A lever 470 is mechanically linked to the tangs 468 such that actuation of the lever 470 recesses the tangs again and allows the fork 466 to be removed again from the receptacle 462.

The lift cart 464 may also double as a patient mobility device (or scooter). Referring to FIG. 39D, the lift cart 464 includes a powered drive wheel and breaks (optionally actuated by pedals 472). The lift column 474 includes a handle bar set 476 mounted thereon, which includes a throttle 478 (or some other control device). The handle bar set 476 in FIG. 39D faces outwardly from the position of the fork so that it is oriented for controlling by a nurse or some other assistant. However, the handle bar set 476 in these embodiments is capable of being rotated 180° so that it faces the patient. Thus, if the pallet support 450, having a patient seated thereon, is coupled to the fork 466 such that the pallet support 450 and patient faces the handle bar set 476, the patient may use the pedals 472, handle bar set 476 and/or throttle 478 to individually drive, steer and/or break the motion of the lift cart so that it now operates substantially as a powered patient mobility device.

Referring to FIGS. 39E-39I, a vertical support platform 480 may also be coupled to the lift column 474. The vertical support platform 480 includes two pair of hooks 482 and 484 for respectively hanging a back support strap 486 and a thigh support strap 488 thereto. As shown specifically in FIG. 39H, the vertical support platform 480 and associated straps 486/488 coupled to the lift cart 464 allows a patient to be supported below the platform 480 by the straps 486/488 and thus be transported by the lift cart 464. The vertical support platform 480 may be coupled to the vertical support column 474 by a manipulatable interface coupling 481 and associated control lever 483, which may used to vertically manipulate the vertical support platform up and down the platform as well as pivot the platform (as shown in FIG. 39I).

Referring to FIGS. 39A and 39I, the pallet support 450 includes a lateral recess 490 extending across the padded back-rest portion 454, which can be used to easily and comfortably recess the back support strap 486 therein. As shown primarily in FIG. 39I, this recess 490 allows the back support strap 486 to be easily positioned beneath the patient's back while seated within the pallet support 450 or to be easily removed from behind the patient's back while seated within the pallet support 450; thus, allowing convenient and safe transfer between the pallet support 450 and the vertical support platform and associated straps 486/488. It will be appreciated by those of ordinary skill that the straps 486/44 may be initially coupled to a bed frame, similar to the back-rest pad component 38 as shown in FIGS. 38C-38E, rather than the pallet support 450.

When not in use transporting a patient, the lift cart 464 can occupy the patient's room as a chair as shown in FIG. 39C with the pallet support 450 coupled to the fork 466, or as a table as shown in FIG. 39E with the vertical support platform 480 coupled to the fork 466.

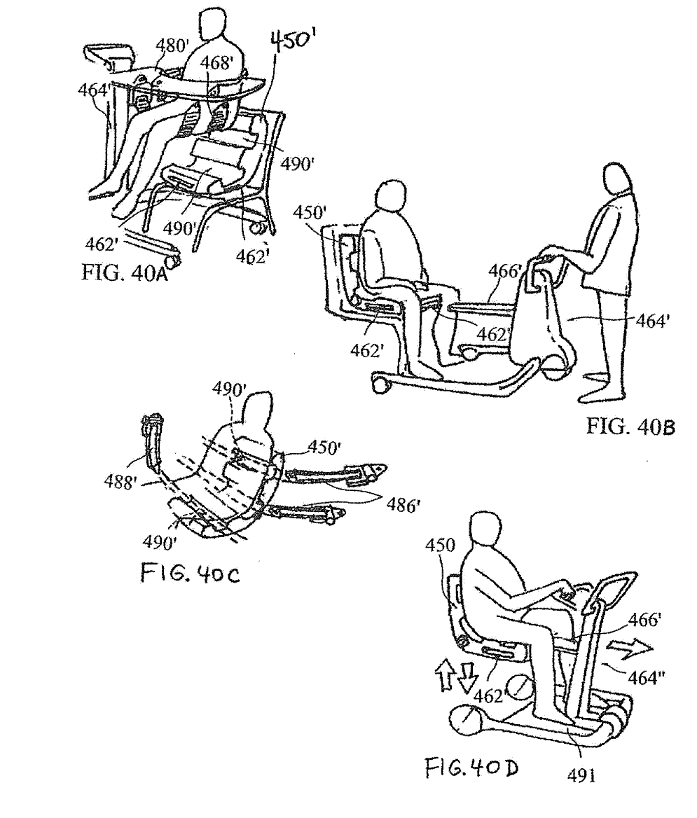

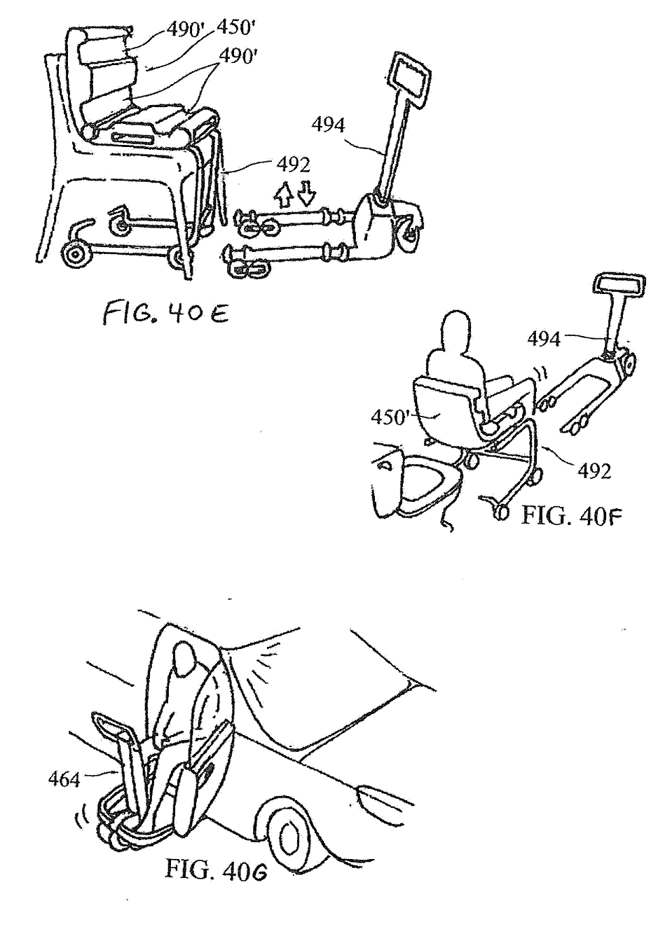

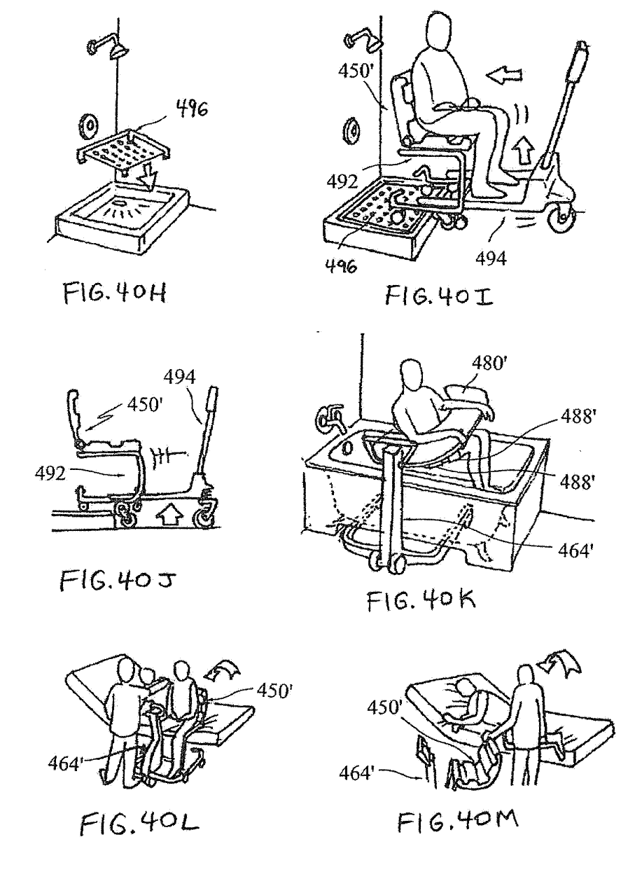

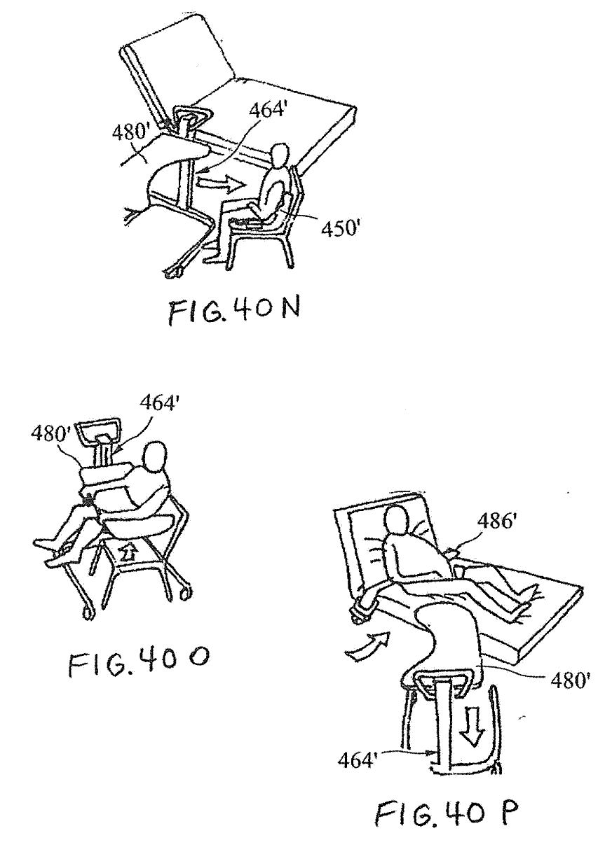

FIGS. 40A-40P depict a very similar embodiment of the pallet support 450′ and associated components as described above in FIGS. 39A-39I. The pallet support 450′ in this alternate embodiment includes additional recesses 490′ in the seat portion and/or back portion of the pallet support 450′ for corresponding straps 468′/488′. FIGS. 40A-40P depict various uses and activities facilitated by the embodiments of FIGS. 39A-39I and 40A-40P. FIG. 40D depicts another alternate cart 464″ that includes a floor portion 491 allowing the patient to rest his or her feet when the cart is used as a scooter. This scooter is also shaped and configured to make room for the patient's legs and feet when used as a scooter. FIGS. 40E, 40F, 401 and 40J also show an optional set of wheeled legs 492 that may be mounted below the pallet support 450′. The cart 494 in this embodiment does not include a lift device because the wheeled legs 492 already elevate the pallet support 450′. Additional accessories, such as a shower platform 496 may also be utilized to facilitate associated activities.

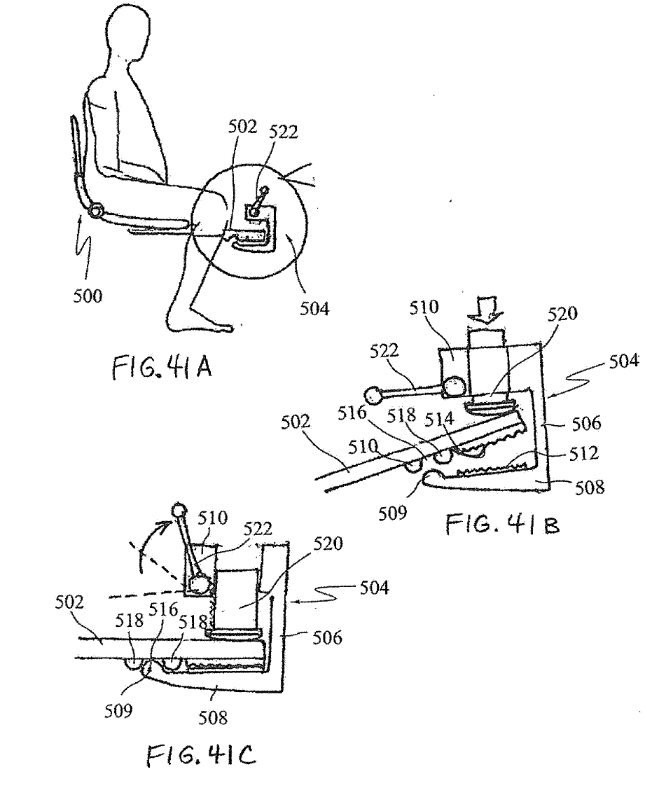

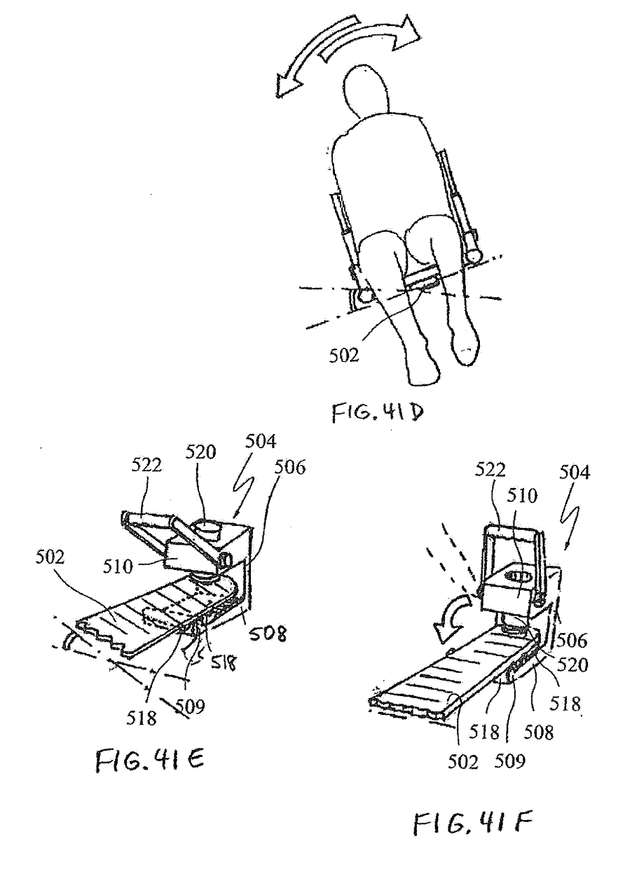

Above, most of the embodiments indicated that the frames or pallets included receptacles or hollow spaces (female couplings) for receiving and being coupled to tines, forks, bars (male couplings) extending from the lift or mobility devices. As will be appreciated by those of ordinary skill in the art, it is certainly within the scope of the invention that the frames or pallets include male couplings and that the lift or mobility devices include female couplings. For example, referring now to FIGS. 41A, 41F, it can be seen that the frame or pallet 500 includes a male arm 502 extending therefrom, which is received within and coupled to a female coupling 504 associated with a lift or mobility device. In the present embodiments, the female coupling includes a c-shaped receiver 506 having a lower, horizontally extending support beam 508 and an upper, horizontally extending clamping beam 510. The lower support beam 508 includes a textured upper surface 512 for mating with a correspondingly textured lower surface 514 of the leading end of the male arm 502. Additionally, the outward end of the lower support beam 508 includes a rib 509 extending laterally thereacross, adapted to be received within a pivot-channel 516 formed by a complementary pair of ribs 518 extending downwardly from the leading end of the male arm 502. To clamp the leading end of the male arm 502 within the c-shaped receiver 506, the pivot-channel 516 is first registered on the rib 509 of the support beam 508 and a piston 520 reciprocatably supported in the clamping beam 510 is actuated to press onto the upper surface of the leading end of the male arm 502 and push the leading end downward (pivoting on the rib 509) such that the corresponding textured surfaces 512/514 engage with other to form a secure coupling. In this embodiment, a lever is 522 is used to actuate the piston 520.

Referring to FIGS. 41D-41F, it can be seen that this design of the female coupling 504 allows the leading end of the male arm 502 to be received within the c-shaped receiver 506 at a substantial lateral and/or vertical angle. The subsequent registration by the complementary rib 509 and channel 516, followed by the clamping of initiated by the piston 520 will ensure a secure and substantially level coupling.

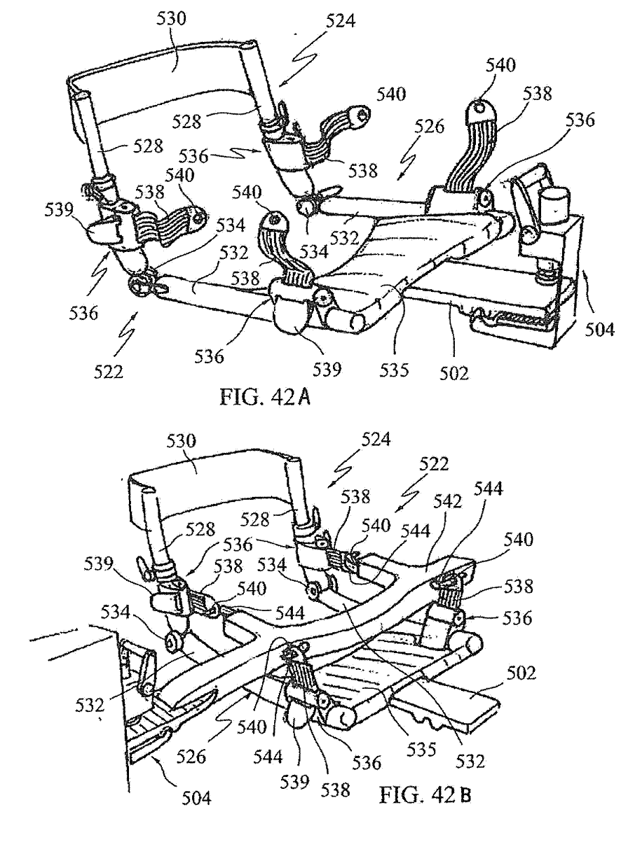

Referring to FIGS. 42A and 42B, an additional exemplary embodiment of a frame 522 for use with the present invention includes the male arm 502 for mating with the female coupling 504 described in detail above. The frame 522 of the present embodiment includes an upper frame section 524 for supporting a torso of a patient and a lower frame section 526 for supporting the thighs of a patient. The upper frame section 524 includes a pair of vertically extending, rigid bars 528 and back-support strap 530 extending laterally between the bars 528. The lower frame section 526 includes a pair of vertically extending, rigid bars 532 pivotally coupled at lockable hinges 534 to the corresponding rigid bars 528 of the upper frame section 524. A rigid seat 535 extends laterally between the lower ends of the rigid bars 532. In this embodiment, each of the rigid bars 528 of the upper frame section 524 and each of the rigid bars 532 of the lower frame section 526 include retractable (spooling) strap mechanisms 536 mounted thereto, each of which include a retractable strap 538 extended therefrom (or retracted therein) and an actuator 539 for initiating retraction of the associated strap 538 therein and/or lock the extension of the strap. In this embodiment, the straps 538 include eyelets 540, which may be used to couple to one or more buckle mechanisms (not shown) to provide a buckled strap or webbing extending over a patient seated thereon and/or a buckled strap extending beneath the patient, for example. It is also within the scope of the invention that one of the straps includes a female buckle component while the other end includes a male buckle component (like a seat belt, for example and without limitation); or, alternatively, it is within the scope of the invention that only one vertical bar includes a retractable strap that is adapted to extend completely across and couple to the opposing vertical bar. Referring specifically to FIG. 42B, the straps 538 may also be utilized for coupling the frame 522 to a support beam 542 extending from a lift device. In the present embodiment, the support beam 542 will extend over a patient's legs and includes hooks 544 for hooking onto the corresponding eyelets 540 of the straps.

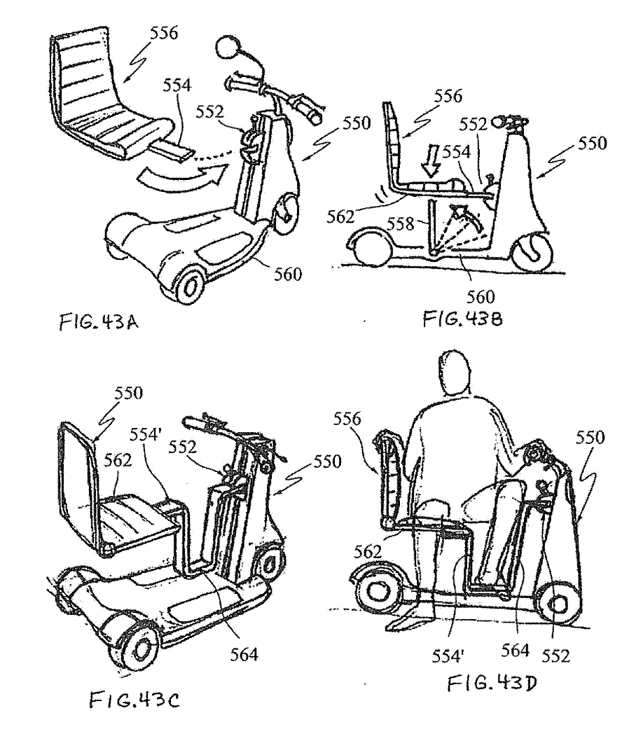

Above embodiments discuss the coupling of the frames or pallets of the present invention to a patient mobility device such as a wheelchair or a scooter. Examples of such scooter interfaces are shown in FIGS. 43A and 43D. The scooter 550 of FIGS. 43A and 43B includes a female clamping mechanism 552 (similar to those described above) for receiving and coupling to a male arm 554 extending from an appropriate frame or pallet component 556 according to the present invention. A pivotal support bar 558 is provided to pivot up from a base 560 of the scooter to provide additional support below the seat 562 of the frame/pallet 556 to for the patient carried by the scooter 550. This support bar 558 can be pivoted back to the base when the frame/pallet 556 is decoupled again from the scooter to allow for easier storage of the scooter (the base of the scooter can be rolled under a bed or a couch for example).

Referring to FIGS. 43C and 43D, the male arm 554′ has been modified to provide a downward extending u-shaped portion 564 positioned between the seat 562 of the frame/pallet 556 and the female clamping mechanism 552 of the scooter. This downward extending u-shaped portion 564 allows easier entry and exit from the scooter 550.

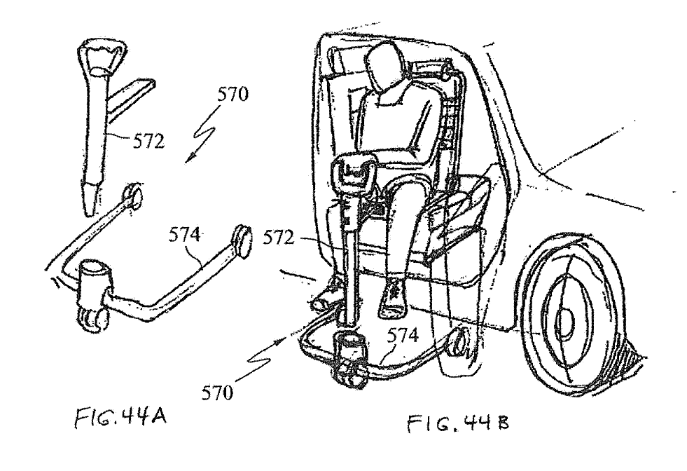

As shown in FIGS. 44A and 44B, a relatively lightweight detachable lift cart 570 is provided for use especially with automobiles. This lift is a scaled down version of the more sturdy lifts described above and is adapted to be taken apart and potentially stored in the vehicle. In this version, the lift column 572 is separable from the mobile base 574.

While the exemplary embodiments described herein utilize wheeled lifts, lift carts, mobility devices and/or scooters for coupling to and transporting the frames/pallets/patients, it is also within the scope of the invention that fixed/stationary lift/transport devices and/or overhead lift/transport and/or staircase lift/transport devices that include carriages for coupling to the various couplings of the frames could also be used.

In sum, the exemplary embodiments described herein all provide a form of rigid support to the human body; the shape and contour of most of the exemplary frames may be modified to aid with activities of daily living; and movement or transfer of the patient can be performed through use of a lifting or mobility cart, which articulates with the frame by inserting its arm(s)/tine(s) into a hollow-space/receptacle provided by or provided under the frame. The exemplary embodiments, therefore, as compared to the prior art devices, may eliminate need for intermediary transfer devices; may provide a more natural body position for transfer; may provide the ability to change body shape to suit a particular task; may utilize a more compact lifting/mobility device; may experience less patient anxiety (no hanging gravity effect as in certain prior art devices), may be less expensive; may require less or no infrastructure; and may ease the patient transfer steps.

While the exemplary frameworks described herein are primarily described utilizing “rigid” components, this term encompasses rigid or substantially rigid components such as metals, graphite composite materials and some plastic or rubber-like materials that provide suitable rigidity for the purposes and uses described herein. In other words, it will be appreciated by those of ordinary skill in the art that absolute rigidity is not necessary for such framework components to fall within the scope of the invention, and that some flexibility may even be desirable for certain applications. Furthermore, for the purposes of the present invention, the frame and pallet systems described herein utilize one or more “frame components” that comprise (a) rigid “framework(s)” (made up of rigid sub-component(s) or assemblies, such as—without limitation—rigid bars, seats, supports and the like) that provide primarily the structural support for the patient and, optionally, (b) flexible or resilient components (such as straps, webbing, cushions, and the like) coupled to or extending from the rigid frameworks that provide primarily (i) additional structural support (such as back straps or webbing, for example) and/or (ii) mechanisms to secure the patient to the rigid framework(s) (such as straps) and/or (iii) provide comfort to the patient (such as head rests or seat cushions).

Following from the above description of the invention, it should be apparent to those of ordinary skill in the art that, while the systems and processes herein described constitute exemplary embodiments of the present invention, it is to be understood that the invention is not limited to these precise systems and processes and that changes may be made therein without departing from the scope of the invention as defined by the claims. Additionally, it is to be understood that it is not necessary to meet any or all of the identified advantages or objects of the invention disclosed herein in order to fall within the scope of any claim, since inherent and/or unforeseen advantages of the present invention may exist even though they may not have been explicitly discussed herein.

What is claimed is:

1. A patient transfer system comprising:
a lift cart including a vertical lift mechanism for lifting a vertical support platform;
said vertical support platform capable of supporting a patient's weight; and
at least two support straps releasably coupled to said vertical support platform;
wherein said at least two support straps may support at least a portion of said patient's torso and said patient's thighs such that said patient's hips rest lower than the top of said vertical support platform, said patient's head rests higher than said top of said vertical support platform, and said vertical support platform extends horizontally from said lift cart across said patient's anterior.

2. The patient transfer system of claim 1, wherein said vertical support platform may pivot clockwise or counter-clockwise about its longitudinal axis.

3. The patient transfer system of claim 1, wherein said vertical support platform is removable from said lift cart.

4. The patient transfer system of claim 1, wherein said vertical support platform is removable from said lift cart and said lift cart is adapted to alternatively receive and couple to a patient support frame including a substantially rigid framework adapted to provide support for at least a portion of said patient's torso and said patient's thighs.

5. The patient transfer system of claim 1, wherein said vertical lift mechanism is a powered lift mechanism.

6. The patient transfer system of claim 1, wherein said lift cart includes a plurality of legs extending generally horizontally from a lower end of said lift cart.

7. The patient transfer system of claim 1, wherein said vertical support platform includes a single support beam.

8. The patient transfer system of claim 1, wherein said vertical support platform includes a single support beam and wherein said vertical support platform includes at least one arm attached to said single support beam in a direction perpendicular to the longitudinal axis of said single support beam.

9. The patient transfer system of claim 1, wherein said vertical support platform includes a tabletop.

10. The patient transfer system of claim 1, wherein said lift cart may rest on wheels to allow movement of said lift cart on a supporting surface.

11. The patient transfer system of claim 1, wherein said lift cart may rest on wheels to allow movement of said lift cart on a supporting surface and said wheels are operatively coupled to a powered drive system.

12. The patient transfer system of claim 1, wherein said lift cart is adapted to permit operation by said patient and by a caregiver.

13. The patient transfer system of claim 1, wherein said lift cart includes a steering handle bar and said steering handle bar is pivotable between at least two orientations.

14. The patient transfer system of claim 1, wherein said lift cart includes at least one leg extending generally horizontally from a lower end of said lift cart and at least one wheel is mounted to said leg.

15. The patient transfer system of claim 1, wherein said vertical support platform may rotate about its longitudinal axis to vary the posture of said patient.

16. The patient transfer system of claim 1, wherein said lift cart includes a control device, said control device being pivotable between at least two orientations.

17. A patient transfer system comprising:
a lift cart including a vertical lift mechanism for lifting a vertical support platform;
said vertical support platform capable of supporting a patient's weight; and
at least two support straps releasably coupled to said vertical support platform;
wherein, when said patient is being transported, said at least two support straps support at least a portion of said patient's torso and said patient's thighs such that said patient's waist rests generally below the top of said vertical support platform, said patient's neck rests higher than said top of said vertical support platform, and said vertical support platform extends horizontally from said lift cart generally between said patient's head and said patient's thighs.

18. The patient transfer system of claim 17, wherein said vertical support platform may pivot clockwise or counter-clockwise about its longitudinal axis.

19. The patient transfer system of claim 17, wherein said vertical support platform is removable from said lift cart.

20. The patient transfer system of claim 17, wherein said vertical support platform is removable from said lift cart and said lift cart is adapted to alternatively receive and couple to a patient support frame including a substantially rigid framework adapted to provide support for at least a portion of said patient's torso and said patient's thighs.

21. The patient transfer system of claim 17, wherein said vertical lift mechanism is a powered lift mechanism.

22. The patient transfer system of claim 17, wherein said lift cart includes a plurality of legs extending generally horizontally from a lower end of said lift cart.

23. The patient transfer system of claim 17, wherein said vertical support platform includes a single support beam.

24. The patient transfer system of claim 17, wherein said vertical support platform includes a single support beam and wherein said vertical support platform includes at least one arm attached to said single support beam in a direction perpendicular to the longitudinal axis of said single support beam.

25. The patient transfer system of claim 17, wherein said vertical support platform includes a tabletop.

26. The patient transfer system of claim 17, wherein said lift cart may rest on wheels to allow movement of said lift cart on a supporting surface.

27. The patient transfer system of claim 17, wherein said lift cart may rest on wheels to allow movement of said lift cart on a supporting surface and said wheels are operatively coupled to a powered drive system.

28. The patient transfer system of claim 17, wherein said lift cart is adapted to permit operation by said patient and by a caregiver.

29. The patient transfer system of claim 17, wherein said lift cart includes a steering handle bar and said steering handle bar is pivotable between at least two orientations.

30. The patient transfer system of claim 17, wherein said lift cart includes at least one leg extending generally horizontally from a lower end of said lift cart and at least one wheel is mounted to said leg.

31. The patient transfer system of claim 17, wherein said vertical support platform may rotate about its longitudinal axis to vary the posture of said patient.

32. The patient transfer system of claim 17, wherein said lift cart includes a control device, said control device being pivotable between at least two orientations.

33. A patient transfer system comprising:
a lift cart including a vertical lift mechanism for lifting a vertical support platform;
said vertical support platform extending horizontally from said lift cart and capable of supporting a patient's weight; and
at least two support straps releasably coupled to said vertical support platform;
wherein, when said patient is being transported, said at least two support straps support at least a portion of said patient's torso and said patient's thighs such that said patient's waist rests below the top of said vertical support platform, said patient's head rests above said top of said vertical support platform, and said patient's hips rest generally parallel to the direction of said horizontal extension of said vertical support platform.

34. The patient transfer system of claim 33, wherein said vertical support platform may pivot clockwise or counter-clockwise about its longitudinal axis.

35. The patient transfer system of claim 33, wherein said vertical support platform is removable from said lift cart.

36. The patient transfer system of claim 33, wherein said vertical support platform is removable from said lift cart and said lift cart is adapted to alternatively receive and couple to a patient support frame including a substantially rigid framework adapted to provide support for at least a portion of said patient's torso and said patient's thighs.

37. The patient transfer system of claim 33, wherein said vertical lift mechanism is a powered lift mechanism.

38. The patient transfer system of claim 33, wherein said lift cart includes a plurality of legs extending generally horizontally from a lower end of said lift cart.

39. The patient transfer system of claim 33, wherein said vertical support platform includes a single support beam.

40. The patient transfer system of claim 33, wherein said vertical support platform includes a single support beam and wherein said vertical support platform includes at least one arm attached to said single support beam in a direction perpendicular to the longitudinal axis of said single support beam.

41. The patient transfer system of claim 33, wherein said vertical support platform includes a tabletop.

42. The patient transfer system of claim 33, wherein said lift cart may rest on wheels to allow movement of said lift cart on a supporting surface.

43. The patient transfer system of claim 33, wherein said lift cart may rest on wheels to allow movement of said lift cart on a supporting surface and said wheels are operatively coupled to a powered drive system.

44. The patient transfer system of claim 33, wherein said lift cart is adapted to permit operation by said patient and by a caregiver.

45. The patient transfer system of claim 33, wherein said lift cart includes a steering handle bar and said steering handle bar is pivotable between at least two orientations.

46. The patient transfer system of claim 33, wherein said lift cart includes at least one leg extending generally horizontally from a lower end of said lift cart and at least one wheel is mounted to said leg.

47. The patient transfer system of claim 33, wherein said vertical support platform may rotate about its longitudinal axis to vary the posture of said patient.

48. The patient transfer system of claim 33, wherein said lift cart includes a control device, said control device being pivotable between at least two orientations.
